(19) United States
(12) Patent Application Publication
(10) Pub. No.: US 2002/0016161 A1
(43) Pub. Date: Feb. 7, 2002

(54) Method and apparatus for compression of speech encoded parameters

(75) Inventors: Nidzara Dellien, Lund (SE); Tomas Eriksson, Lund (SE); Fisseha Mekuria, Lund (SE)

Correspondence Address: Ross T. Robinson, Jenkens & Gilchrist, P.C., 1445 Ross Avenue, Suite 3200, Dallas, TX, 75202-2799, US

(73) Assignee: Telefonaktiebolaget LM Ericsson (publ)

(21) Appl. No.: 09/772,444

(22) Filed: Jan. 29, 2001

Related U.S. Application Data
(60) Provisional application No. 60/181,503, filed on Feb. 10, 2000.

(51) Int. Cl. H04B 1/66

(52) U.S. Cl. 455/403; 704/500; 375/240

(57) ABSTRACT

A communication apparatus having a speech encoder and speech decoder able to retrieve and store voice messages in memory is described. The messages are stored in the memory according to a more compressed message format than the speech-encoding format of the speech encoder. The apparatus includes a frame interpolation block for decompressing stored messages and thereby creating a signal in the speech-encoding format. A frame-decimation block compresses a speech-encoded signal, thereby allowing a corresponding voice message to be stored in the memory in the message format. A statistical analysis is performed to determine inter-frame redundancy of parameters of the encoded signal. A portion of those parameters having relatively high inter-frame redundancy are compressed using a lossless compression algorithm, while a portion of those parameters having relatively low inter-frame redundancy are compressed using a lossy compression algorithm. Other parameters are not compressed according to pre-determined criteria irrespective of their inter-frame redundancy.

### RELATED APPLICATIONS

This patent application claims priority from and incorporates by reference U.S. Provisional Patent Application No. 60/181,503, filed on Feb. 10, 2000.

### BACKGROUND OF THE INVENTION

1. Technical Field of Invention

The present invention relates to the wireless communications field and, in particular, to a communications apparatus and method for compressing speech encoded parameters prior to, for example, storing them in a memory. The present invention also relates to a communications apparatus and method for improving the speech quality of decompressed speech encoded parameters.

2. Description of Related Art

A communication apparatus adapted to receiving and transmitting audio signals is often equipped with a speech encoder and a speech decoder. The purpose of the encoder is to compress an audio signal that has been picked up by a microphone. The speech encoder provides a signal in accordance with a speech encoding format. By compressing the audio signal the bandwidth of the signal is reduced and, consequently, the bandwidth requirement of a transmission channel for transmitting the signal is also reduced. The speech decoder performs substantially the inverse function of the speech encoder. A received signal, coded in the speech encoding format, is passed through the speech decoder and an audio signal, which is later output by a loudspeaker, is thereby recreated.

One known form of a communication apparatus being able to readout and store voice messages in a memory is discussed in U.S. Pat. No. 5,499,286 to Kobayashi. A voice message is stored in the memory as data coded in the speech encoding format. The speech decoder of the communication apparatus is used to decode the stored data and thereby recreate an audio signal of the stored voice message. Likewise, the speech encoder is used to encode a voice message, picked up by the microphone, and thereby provide data coded in the speech encoding format. This data is then stored in the memory as a representation of the voice message. U.S. Pat. No. 5,630,205 to Ekelund illustrates a similar design.

While the known communication apparatus described above functions quite adequately, it does have a number of disadvantages. A drawback of the known communication apparatus is that although the speech encoder and speech decoder allow message data to be stored in a memory in a compressed format, a relatively large memory is still needed. Memory is expensive and is often a scarce resource, especially in small hand-held communication devices, such as cellular or mobile telephones.

An example of a speech encoding/decoding algorithm is defined in the GSM (Global System for Mobile communications) standard, in which a residual-pulse-excited long-term prediction (RPE-LTP) coding algorithm is used. This algorithm, which is referred to as a full-rate speech-coder algorithm, provides a compressed data rate of about 13 kilobits/second (kbps). Memory requirements for storing voice messages are therefore relatively high. Computational power needed for performing the full-rate speech coding algorithm is, however, relatively low (about 2 million instructions/second(MIPS)).

The GSM standard also includes a half-rate speech coder algorithm, which provides a compressed data rate of about 5.6 kbps. Although this means that a memory requirement for storing voice messages is lower than what is required when the full-rate speech coding algorithm is used, the half-rate speech code algorithm does require considerably more computational power (about 16 MIPS).

Computational power is expensive to implement and is also often a scarce resource, especially in small hand-held communication devices, such as cellular or mobile telephones. Furthermore, a circuit for carrying out a high degree of computational power also consumes considerable electrical power, which adversely affects battery life length in battery-powered communication devices.

Mobile telephones are becoming smaller and smaller while at the same time offering more and more functions. One of these functions is a voice memo function, by which a mobile telephone user can record a short message either from an uplink (i.e., by the user) or a downlink (i.e., by another person with whom the user is communicating). Because the voice memo is recorded in the mobile telephone itself, storing a voice memo speech signal in an uncoded form would consume far too much memory. Under the GSM standard, either the half-rate speech or the full-rate encoder can currently be used. In the near future, GSM will use a tandem connection of adaptive multi-rate (AMR) speech encoder-decoders (codecs) that operate in different modes (e.g., at different bit rates).

Compression of a source input can be accomplished with or without a loss of input signal (e.g., speech) information. In A Mathematical Theory of Communication, Bell. Syst. Tech. Journal, Vol. 27, No. 3, July, 1948, pp. 379-423, C. E. Shannon showed that coding could be separated into source coding and channel coding. In the context of speech encoding, because the source is speech, source coding equals speech coding. Shannon's source coding theorem states that an information source U is completely characterized by its entropy, H(U). The theorem also states that the source can be arbitrarily represented if a transmission rate (R) satisfies the relation R>H without any loss of information.

The purpose of the channel encoder is to protect the output of the source (e.g., speech) encoder from possible errors that could occur on the channel. This can be accomplished by using either block codes or convolutional (i.e, error-correcting) codes. Shannon's channel coding theorem states that a channel is completely characterized by one parameter, termed channel capacity (C), and that R randomly chosen bits can be transmitted with arbitrary reliability only if R<C.

Under the GSM standard, the speech encoder takes its input in the form of a 13-bit uniform quantized pulse-code-modulated (PCM) signal that is sampled at 8 kiloHertz (kHz), which corresponds to a total bit rate of 104 kbps. The output bit rate of the speech encoder is either 12.2 kbps if an enhanced full-rate (EFR) speech encoder is used or 4.75 kbps if an adaptive multi-rate (AMR) speech encoder is used. The EFR and AMR encoders result in compression ratios of 88% and 95%, respectively.

The primary objective of speech coding is to remove redundancy from a speech signal in order to obtain a more useful representation of speech-signal information. Model-based speech coding, also known as analysis-by-synthesis, is based on linear predictive coding (LPC) synthesis. In model-based speech coding, a speech signal is modeled as a linear filter. In the encoder, linear prediction (LP) is performed on speech segments (i.e., frames). Since the same filter exists both in the encoder and the decoder, only the filter parameters need to be transmitted. A filter in the decoder is excited by random noise to produce an estimated speech signal. Because the filter has only a finite number of parameters, it can generate only a finite number of realizations. Since more distortion can be tolerated in formant regions, a weighting filter (W(z)) is introduced.

Using a vector quantizer approach, an algorithm that uses a codebook can be developed, resulting in a Code Excitation Linear Predictor (CELP) encoder/decoder (codec). In a CELP scheme, a long-term filter is replaced by an adaptive codebook scheme that is used to model pitch frequency, and an autoregressive (AR) filter is used for short-time synthesis. The codebook consists of a set of vectors that contain different sets of filter parameters. To determine optimal parameters, the whole codebook is sequentially searched. If the structure of the codebook is algebraic, the codec is referred to as an algebraic CELP (ACELP) codec. This type of codec is used in the EFR speech codec used in GSM.

EFR SPEECH CODEC

The GSM EFR speech encoder takes an input in the form of a bit-uniform PCM signal. The PCM signal undergoes level adjustment, is filtered through an anti-aliasing filter, and is then sampled at a frequency of 8 kHz (which gives 160 samples per 20 ms of speech). The EFR codec compresses an input speech data stream 8.5 times.

Pre-Processing

Before the signal is sent to the EFR speech encoder, some pre-processing is needed. To avoid calculations resulting in fixed-point overflow, the input signal is divided by 2. The second part of the pre-processing is to high-pass filter the signal, which removes unwanted low-frequency components. A cut-off frequency is set at 80 Hz. A combined high-pass and down-scale is given by, for example:

$${H}_{h1} ( z ) = \frac{0.92727435 - 1.8544941 {z}^{- 1} + 0.92727435 {z}^{- 2}}{1 - 1.9059465 {z}^{- 1} + 0.9114024 {z}^{- 2}} \cdot \frac{1}{2} \qquad ( 1 )$$

EFR Encoder

When used in the GSM EFR codec, the ACELP algorithm operates on 20 ms frames that correspond to 160 samples. For each frame, the algorithm produces 244 bits at 12.2 kbps. Transformation of voice samples to parameters that are then passed to a channel encoder includes a number of steps, which can be divided into computation of parameters for short-term prediction (LP coefficients), parameters for long-term prediction (pitch lag and gain), and algebraic codebook vector and gain. The parameters are computed in following order: 1) short-term prediction analysis; 2) long-term prediction analysis; and 3) algebraic code vectors.

Linear Prediction (LP) is a widely-used speech-coding technique, which can remove near-sample or distant-sample correlation in a speech signal. Removal of near-sample correlation is often called short-term prediction and describes the spectral envelope of the signal envelope very efficiently. Short-term prediction analysis yields an AR model of the vocal apparatus, which can be considered constant over the 20 ms frame, in the form of LP coefficients. The analysis is performed twice per frame using an auto-correlation approach with two different 30 ms long asymmetric windows. The windows are applied to 80 samples from a previous frame and 160 samples from a current frame. No samples from future frames are used. The first window has its weight on the second subframe and second window on the fourth subframe.

The speech signal is convolved with these two windows, resulting in windowed speech (s′(n)) with n=0, . . . , 239, for which eleven auto-correlation coefficients, r_{ac}(k), are calculated. The auto-correlation coefficients are then used to obtain ten LP coefficients, aₖ, by solving the equation:

$${\sum }_{k = 1}^{10} {a}_{k} {r}_{ac} ( \vert i - k \vert ) = - rac ( i ) , i = 0 , … , 10 \qquad ( 2 )$$

This equation is solved using the Levinson-Durbin algorithm. The LP coefficients (aₖ) are the coefficients of the synthesis filter represented by the equation:

$$H ( z ) = \frac{1}{A ( z )} \qquad ( 3 )$$

To reduce the number of bits needed to encode the LP parameters, the LP parameters are first converted to a Line Spectral Pair (LSP) representation. The LSP representation is a different way to describe the LP coefficients. In the LSP representation, all parameters are on a unit circle and can be described by their frequencies only.

The conversion from LP to LSP is performed because an error in one LSP frequency only affects speech near that frequency and has little influence on other frequencies. In addition, LSP frequencies are better-suited for quantization than LP coefficients. The LP-to-LSP conversion results in two vectors containing ten frequencies each, in which the frequencies vary from 0-4 kHz.

To reduce even further the number of bits needed for quantizing, the frequency vectors are predicted and the differences between the predicted and real values are calculated. A first order moving-average (MA) predictor is used. The two residual frequency vectors are first combined to create a 2×10 matrix; next, the matrix is split into five submatrices. The submatrices are vector quantized with 7, 8, 8+1, 8 and 6 bits, respectively.

For the computation of long-term prediction parameters and the excitation vector, both quantized and unquantized LP coefficients are needed in each subframe. The LP coefficients are calculated twice per frame and are used in subframes 2 and 4. The LP coefficients for the 1st and 3rd subframes are obtained using linear interpolation.

The long-term (i.e., pitch) synthesis filter is given by the equation:

$$\frac{1}{B ( z )} = \frac{1}{1 - {g}_{p} {z}^{- T}} \qquad ( 4 )$$

wherein T is pitch delay and gₚ is pitch gain. The pitch synthesis filter is implemented using an adaptive codebook approach. To simplify the pitch analysis procedure, a two-stage approach is used. First, an estimated open-loop pitch (Tₒₚ) is computed twice per frame, and then a refined search is performed around Tₒₚ in each subframe. A property of speech is that pitch delay is between 18 samples (2.25 ms) and 143 samples (17.857 ms), so the search is performed within this interval.

Open-loop pitch analysis is performed twice per frame (i.e., 10 ms corresponding to 80 samples) to find two estimates of pitch lag in each frame. The open-loop pitch analysis is based on a weighted speech signal (s_{w}), which is obtained by filtering the input speech signal through a perceptual weighting filter.

The perceptual weighting filter is given by the equation:

$$W ( z ) = \frac{A ( z / {γ}_{1} )}{A ( z / {γ}_{2} )} , 0 ≺ {γ}_{2} ≺ {γ}_{1} \leq 1 \qquad ( 5 )$$

The perceptual weighting filter is introduced because the estimated signal, which corresponds to minimal error, might not be the best perceptual choice, since more distortion can be tolerated in formant regions. The values γ₁=0.9, γ₂=0.6 are used.

First, auto-correlation represented by the equation:

$${O}_{k} = {\sum }_{n = 0}^{79} {s}_{ω} ( n ) {s}_{ω} ( n - k ) \qquad ( 6 )$$

is calculated in three different sample ranges:

i=3: 18, . . . , 35,

i=2: 36, . . . , 71,

i=1: 72, . . . , 143.

In each range, a maximum value is found and normalized. The best pitch delay among these three is determined by favoring delays in the lower range. The procedure of dividing the delay range into three sample ranges and favoring lower ones is used to avoid choosing pitch multiples.

The adaptive codebook search is performed on a subframe basis. It consists of performing a closed-loop pitch search and then computing the adaptive code vector. In the first and third subframes, the search is performed around Tₒₚ with resolution of ⅙ if Tₒₚ is in the interval 17 3/6-94 3/6 and integers only if Tₒₚ is in the interval 95-143. The range of Tₒₚ±3 is searched. In the second and fourth subframes, the search is performed around the nearest integer value (T_{I}) to the fractional pitch delay in the previous frame. The resolution of ⅙ is always used in the interval T_{I}−5 3/6-T_{I}+4 3/6. The closed-loop search is performed by minimizing the mean square weighted error between original and synthesized speech. The pitch delay is encoded with 9 bits in the 1st and 3rd subframes and relative delays of 2nd and 4th subframes are encoded with 6 bits. Once the fractional pitch is found, the adaptive codebook vector, v(n), is computed by interpolating the last excitation u(n) at the given integer part of the pitch delay k and its fractional part t:

$$\begin{matrix}υ ( n ) = {\sum }_{i = 0}^{9} u ( n - k - i ) \cdot {b}_{60} ( t + i \cdot 6 ) + \\ {\sum }_{i = 0}^{9} u ( n - k + 1 + i ) \cdot {b}_{60} ( 6 - t + i \cdot 6 ) , \\ n = 0 , … , 39 , t = 0 , … , 5\end{matrix} \qquad ( 7 )$$

The interpolation filter b₆₀ is based on a Hamming windowed sin(x)/x function.

Since the adaptive codebook vector gives information about pitch delay only, pitch gain must be calculated in order to determine pitch amplitude. An impulse response of the weighted synthesis filter H(z)·W(z) is denoted with h(n) and the target signal for the codebook search with x(n)·x(n) is found by subtracting a zero input response of the weighted synthesis filter H(z)·W(z) from the weighted speech signal s_{ω}. Both h(n) and x(n) are calculated on subframe basis. If y(n)=v(n)*h(n) is the filtered adaptive vector, the pitch gain is given by the equation:

$${g}_{p} = \frac{{\sum }_{n = 0}^{39} x ( n ) y ( n )}{{\sum }_{n = 0}^{39} {( y ( n ) )}^{2}} \qquad ( 8 )$$

The computed gain is quantified using 4-bit a non-uniform quantization in the range 0.0-1.2.

The excitation vector for the LP filter is a pseudo-random signal for voiced sounds and a noise-like signal for unvoiced sounds. When the adaptive code vector (v(n)), which contains information about pitch delay and pitch amplitude, is calculated, the remaining “noise-like” part c(n) of the excitation vector u(n) needs to be calculated. This vector is chosen so that the excitation vector (u(n)=v(n)+c(n)) minimizes the mean square error between the weighted input speech and weighted synthesized speech.

In this codebook, the innovation vector contains only 10 non-zero pulses. All pulses can have an amplitude of +1 or −1. Each 5 ms long subframe (i.e., 40 samples) is divided into 5 tracks. Each track contains two non-zero pulses that can be placed in one of eight predefined positions. Each pulse position is encoded with 3 bits and Gray coded in order to improve robustness against channel errors. For the two pulses in the same track, only one sign bit is needed. This sign indicates the sign of the first pulse. The sign of the second pulse depends on its position relative to the first pulse. If the position of the second pulse is smaller, then it has the opposite sign as the first pulse, otherwise it has the same sign as the first pulse. This gives a total of 30 bits for pulse positions and 5 bits for pulse signs. Therefore, an algebraic codebook with 35-bit entries is needed.

The algebraic codebook search is performed by minimizing the mean square error between the weighted input signal and the weighted synthesized signal. The algebraic structure of the codebook allows a very fast search procedure because the innovation vector (c(n)) consists of only few nonzero pulses. A non-exhaustive analysis-by-syntheses search technique is designed so that only a small percentage of all innovation vectors are tested. If x₂ is the target vector for the fixed codebook search and z is the fixed codebook vector (c(n)) convolved with h(n), the fixed codebook gain is given by the equation:

$${g}_{c} = \frac{{\sum }_{n = 0}^{39} x ( n ) y ( n )}{{\sum }_{n = 0}^{39} {( y ( n ) )}^{2}} \qquad ( 9 )$$

The fixed codebook gain is predicted using fourth order moving average (MA) prediction with fixed coefficients. The correction factor between gain (g_{c}) and predicted gain (g′_{c}) is given by the equation:

$${γ}_{gc} = \frac{{g}_{c}}{{g}_{c}^{′}} . \qquad ( 10 )$$

The correction factor is quantized with 5 bits in each subframe resulting in quantized correction factor \hat{γ}_{gc}.

EFR Decoder

The speech decoder transforms the parameters back to speech. The parameters to be decoded are the same as the parameters coded by the speech encoder, namely, LP parameters as well as vector indices and gains for the adaptive and fixed codebooks, respectively. The decoding procedure can be divided into two main parts. The first part includes decoding and speech synthesis and the second part includes post-processing.

First, the LP filter parameters are decoded by interpolating the received indices given by the LSP quantization. The LP filter coefficients (aₖ) are produced by converting the interpolated LSP vector. The aₖ coefficients are updated every frame.

In each subframe, a number of steps are repeated. First, the contribution from the adaptive codebook (v(n)) is found by using the received pitch index, which corresponds to the index in the adaptive codebook. Then the received index for the adaptive codebook gain is used to find the quantified adaptive codebook gain (ĝₚ) from a table.

The index to the algebraic codebook is used to find the algebraic code vector (c(n)) and then the estimated fixed codebook gain (g′_{c}) can be determined by using the received correction factor \hat{γ}_{gc}. This gives the quantified fixed codebook gain:

ĝ_{c}=\hat{γ}_{gc}·g′_{c} (11)

Now all the parameters needed to reconstruct the speech have been calculated.

Thus, the excitation of the synthesis filter can be represented as:

u(n)=ĝₚv(n)+ĝ_{c}c(n) (12)

and reconstructed speech of a 5 ms long subframe can be written as

$$\hat{s} ( n ) = u ( n ) - {\sum }_{i = 1}^{10} {\hat{a}}_{i} \cdot \hat{s} ( n - i ) n = 0 , … , 39 \qquad ( 13 )$$

where â₁ are the decoded coefficients of the LP filter.

For post processing, two filters are applied in an adaptive post-filtering process. The first filter, a formant post filter designed to compensate for the weighting filter, is represented by:

$${H}_{f} ( z ) = \frac{\hat{A} ( z / {γ}_{n} )}{\hat{A} ( z / {γ}_{d} )} \qquad ( 14 )$$

The first filter is designed to compensate for the weighting filter of equation 5. The values γₙ=0.77 and γ_{d}=0.75 are used.

A second filter is needed to compensate for the tilt of equation 14:

Hₜ(z)=(1−μz¹) (15)

wherein μ is a tilt factor (μ=0.8). In equation 14, Â(z) is the LP inverse filter (both quantized and interpolated). The output signal from the first and second filters is the post-filtered speech signal (ŝ_{f}(n)). The final part of the post-processing is to compensate for the down-scaling performed during the pre-processing. Thus, ŝ_{f}(n) is multiplied by a factor of 2. After the post processing, the signal is passed through a digital-to-analog converter to an output such as, for example, an earphone.

EFR Allocation

The EFR encoder produces 244 bits for each of the 20 ms long speech frames corresponding to a bit rate of 12.2 kbps. The speech is analyzed and the number of parameters that represent speech in that frame are computed. These parameters are the LPC coefficients that are computed once per frame and parameters that describe an excitation vector (computed four times per frame). The excitation vector parameters are pitch delay, pitch gain, algebraic code gain, and fixed codebook gain. Bit allocation of the 12.2 kbps frame is shown in Table 1.

TABLE 1
Bit allocation of the 244 bit frame.

| | 1st & 3rd | 2nd & 4th | |
|---|---|---|---|
| Parameter | subframes | subframes | Total per frame |
| 2 LSP sets | | | 38 |
| Pitch delay | 9 | 6 | 30 |
| Pitch gain | 4 | 4 | 16 |
| Algebraic code | 35 | 35 | 140 |
| Codebook gain | 5 | 5 | 20 |
| Total | | | 244 |

Even though all of the parameters in Table 1 are important for the synthesis of speech in the decoder, because most of the redundancy within the 20 ms speech frame is removed by the speech encoder, the parameters are not equally important. Therefore, the parameters are divided into two classes. The classification is performed at the bit level. Bits belonging to different classes are encoded differently in the channel encoder. Class 1 bits are protected with eight parity bits and Class 2 bits are not protected at all.

Parameters that are classified as protected are: LPC parameters, adaptive codebook index, adaptive codebook gain, fixed codebook gain, and position of the first five pulses in the fixed codebook and their signs. This classification is used to determine if some parameters in the 244 bit frame can be skipped in order to compress the data before saving it to memory.

AMR SPEECH CODEC

The adaptive multi-rate (AMR) codec is a new type of speech codec in which, depending on channel performance, the number of bits produced by the speech encoder varies. If the channel performance is “good,” a larger number of bits will be produced, but if the channel is “bad” (e.g., noisy), only a few bits are produced, which allows the channel encoder to use more bits for error protection. The different modes of the AMR codec are 12.2, 10.2, 7.95, 7.4, 6.7, 5.9, 5.15 and 4.75 kbps.

Pre-Processing

As with the EFR codec, the first step in the AMR encoding process is a low-pass and down-scaling filtering process. AMR also uses a cut-off frequency of 80 Hz. The AMR filter is given by the equation:

$${H}_{h1} ( z ) = \frac{\begin{matrix}0.927246093 - 1.8544941 {z}^{- 1} + \\ 0.927246903 {z}^{- 2}\end{matrix}}{1 - 1.906005859 {z}^{- 1} + 0.911376953 {z}^{- 2}} \cdot \frac{1}{2} \qquad ( 16 )$$

AMR Encoder

LP analysis is performed twice per frame for the 12.2 kbps mode and once per frame for all other modes. An auto-correlation approach is used with a 30 ms asymmetric window. A look ahead of 40 samples is used when calculating the auto-correlation. The window consists of two parts: a Hamming window and a quarter-cosine cycle.

Two sets of LP parameters are converted to LSP parameters and jointly quantized using Split Matrix Quantization (SMQ), with 38 bits for the 12.2 kbps mode. For all other modes, only one set of parameters is converted to LSP parameters and vector-quantized using Split Vector Quantization (SVQ). The 4.75 kbps mode uses a total of 23 bits for the LSP parameters. For the 4.75 kbps mode, the set of quantified and unquantized LP parameters is used for the fourth subframe whereas the first, second, and third subframes use linear interpolation of the parameters in adjacent subframes.

An open pitch lag is estimated every second subframe (except for the 5.15 and 4.75 kbps modes, for which it is estimated once per frame) based on a perceptually-weighted speech signal. Factors in the weighting filter of equation 5 are set to γ₁=0.9 for the 12.2 and 10.2 kbps modes, and to γ₁=0.94 for all other modes. γ₂=0.6 is used for all the modes. Different ranges and resolutions of the pitch delay are used for different modes.

For all modes, an algebraic codebook structure is based on an interleaved singlepulse permutation (ISPP) design. The differences between the modes lie in the number of non-zero pulses in an innovation vector and number of tracks used (e.g., for the 4.75 kbps mode, 4 tracks are used, with each containing 1 non-zero pulse). The differences yield a different number of bits for the algebraic code. For all modes, the algebraic codebook is searched by minimizing the mean-squared error between the weighted input speech signal and the weighted synthesized speech. However, the search procedure differs slightly among the different modes.

The process of predicting the fixed codebook gain is the same for all modes, but different constants are used for the computation of the correction factor (γ_{gc}). When vector-quantizing the adaptive codebook gain (gₚ) and γ_{gc}, a codebook consisting of 5-7 bits is used.

AMR Decoder

The EFR and AMR decoders operate similarly, but there are some differences. For all AMR modes (except the 12.2 kbps mode) a smoothing operation of fixed codebook gain is performed to avoid unnatural energy-contour fluctuations. Because the algebraic fixed codebook vector consists only of a few non-zero pulses, perceptual artifacts will arise. An anti-sparseness process (c(n)) is applied to reduce these effects.

In the AMR decoder, post-processing consists of an adaptive post-filtering process and a combined high-pass and up-scaling filter, given by:

$${H}_{h2} ( z ) = 2 \cdot \frac{\begin{matrix}0.939819335 - 1.879638672 {z}^{- 1} + \\ 0.939819335 {z}^{- 2}\end{matrix}}{1 - 1.933105469 {z}^{- 1} + 0.935913085 {z}^{- 2}} \qquad ( 17 )$$

wherein the cut-off frequency is set to 60 Hz.

AMR Bit Allocation

Bit allocation of the 4.75 kbps mode is shown in Table 2:

TABLE 2
Bit allocation of AMR 4.75 kbps mode

| | 1st | 2nd | 3rd | 4th | Total per |
|---|---|---|---|---|---|
| Parameter | subframe | subframe | subframe | subframe | frame |
| LSP set | | | | | 23 |
| Pitch delay | 8 | 4 | 4 | 4 | 20 |
| Algebraic | 9 | 9 | 9 | 9 | 36 |
| code | | | | | |
| Gains | 8 | — | 8 | — | 16 |
| Total | | | | | 95 |

Therefore, there is a need for a compression algorithm that further compresses a bitstream produced by a speech encoder (i.e., a bitstream already compressed using, for example, an EFR or AMR encoder) before storing the bit stream in a memory. This compression should preferably be performed using only information contained in the bitstream (i.e., preferably no side information from a codec is used). The algorithm should be simple to implement, have low computational complexity, and work in real-time. It is therefore an object of the present invention to provide a communication apparatus and method that overcome or alleviate the above-mentioned problems.

### SUMMARY

According to an aspect of the present invention, there is provided a communication apparatus comprising a microphone for receiving an acoustic voice signal thereby generating a voice signal, a speech encoder adapted to encoding the voice signal according to a speech encoding algorithm, the voice signal thereby being coded in a speech encoding format, a transmitter for transmitting the encoded voice signal, a receiver for receiving a transmitted encoded voice signal, the received encoded voice signal being coded in the speech encoding format, a speech decoder for decoding the received encoded voice signal according to a speech decoding algorithm, a loudspeaker for outputting the decoded voice signal, a memory for holding message data corresponding to at least one stored voice message, memory read out means for reading out message data corresponding to a voice message from the memory and code decompression means for decompressing read out message data from a message data format to the speech encoding format.

According to another aspect of the present invention there is provided a voice message retrieval method comprising the steps of reading out message data coded in a message data format from the memory, decompressing the read out message data to the speech encoding format by means of a decompression algorithm, decoding the decompressed message data according to the speech decoding algorithm, and passing the decoded message data to the loudspeaker for outputting the voice message as an acoustic voice signal.

According to another aspect of the present invention there is provided a voice message retrieval method comprising the steps of reading out message data coded in a message data format from the memory, decompressing the read out message data to the speech encoding format by means of a decompression algorithm and passing the decompressed message data to the transmitter for transmitting the voice message from the communication device.

These apparatus and methods achieve the advantage that a voice message is stored in the memory in a more compressed format than the format provided by a speech encoder. Such a stored voice message is decompressed by the decompression means thereby recreating an encoded voice signal coded in the speech encoding format, i.e. the format provided after a voice signal has passed a speech encoder.

The communication apparatus preferably further comprises code compression means for compressing an encoded voice signal coded in the speech encoding format thereby generating message data coded in the message data format and memory write means for storing the compressed message data in the memory as a stored voice message.

According to another aspect of the present invention there is provided a voice message storage method comprising the steps of converting an acoustic voice signal to a voice signal by means of a microphone, encoding the voice signal by means of the speech encoding algorithm thereby generating an encoded voice signal coded in the speech encoding format, compressing the encoded voice signal according to a compression algorithm thereby generating message data coded in the message data format and storing the compressed message data in the memory as a stored voice message.

According to another aspect of the present invention there is provided a voice message storage method comprising the steps of receiving a transmitted encoded voice signal coded in the speech encoding format, compressing the received encoded voice signal according to a compression algorithm thereby generating message data coded in the message data format and storing the compressed message data in the memory as a stored voice message.

According to another aspect of the present invention there is provided a method for decompressing a signal comprising the steps of decompressing, within a decompressing unit, a compressed encoded digital signal using a lossless scheme and a lossy scheme, decoding, within a decoder, the decompressed signal, and outputting the decoded signal.

These apparatuses and methods achieve the advantage that a user can store a voice message in the memory in a more compressed format compared to the speech encoding format.

Since a voice message is stored in the memory in a more compressed format than the format provided by a speech encoder, as is the case in the prior art, less memory is required to store a particular voice message. A smaller memory can therefore be used. Alternatively, a longer voice message can be stored in a particular memory. Consequently, the communication apparatus of the present invention requires less memory and, hence, is cheaper to implement. In, for example, small hand-held communication devices, where memory is a scarce resource, the smaller amount of memory required provides obvious advantages. Furthermore, a small amount of computational power is required due to the fact that simple decompression algorithms can be used by the decompression means.

### BRIEF DESCRIPTION OF THE DRAWINGS

FIG. 1 illustrates an exemplary block diagram of a communication apparatus in accordance with a first embodiment of the present invention;

FIG. 2 illustrates an exemplary block diagram of a communication apparatus in accordance with a second embodiment of the present invention;

FIG. 3 illustrates an exemplary block diagram of a communication apparatus in accordance with a third embodiment of the present invention;

FIG. 4 illustrates an exemplary block diagram of a communication apparatus in accordance with a fourth embodiment of the present invention;

FIG. 5 illustrates an exemplary block diagram of a communication apparatus in accordance with a fifth embodiment of the present invention;

FIG. 6 illustrates exemplary normalized correlation between a typical frame and ten successive frames for an entire frame and for LSF parameters;

FIG. 7 illustrates exemplary intra-frame correlation of EFR sub-frames;

FIG. 8 illustrates an exemplary probability distribution of values of LSF parameters for an EFR codec;

FIG. 9 illustrates an exemplary probability distribution of bits 1-8, 9-16, 17-23, 24-31, and 41-48 for an AMR 4.75 kbps mode codec;

FIG. 10 illustrates an exemplary probability distribution of bits 49-52, 62-65, 75-82, and 83-86 for an AMR 4.75 kbps mode codec;

FIG. 11 illustrates an exemplary lossy compression algorithm according to lossy method 4 with n=12;

FIG. 12 illustrates an exemplary context tree with depth D=2;

FIG. 13 illustrates exemplary encoding and decoding according to the More-to-Front method; and

FIG. 14 illustrates a block diagram of an exemplary complete compression system in accordance with the present invention.

### DETAILED DESCRIPTION

Embodiments of the present invention are described below, by way of example only. The block diagrams illustrate functional blocks and their principal interconnections and should not be mistaken as illustrating specific implementations of the present invention.

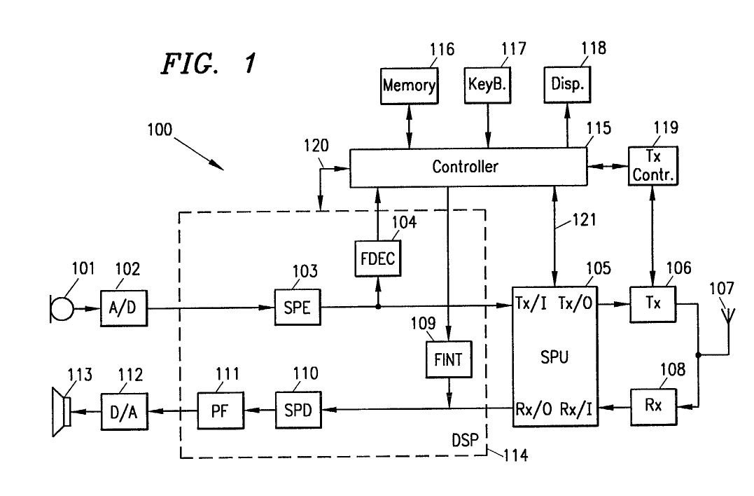

Referring now to the FIGURES, FIG. 1 illustrates a block diagram of an exemplary communication apparatus 100 in accordance with a first embodiment of the present invention. A microphone 101 is connected to an input of an analog-to-digital (A/D) converter 102. The output of the A/D converter is connected to an input of a speech encoder (SPE) 103. The output of the speech encoder is connected to the input of a frame decimation block (FDEC) 104 and to a transmitter input (Tx/I) of a signal processing unit, SPU 105. A transmitter output (Tx/O) of the signal processing unit is connected to a transmitter (Tx) 106, and the output of the transmitter is connected to an antenna 107 constituting a radio air interface. The antenna 107 is also connected to the input of a receiver (Rx) 108, and the output of the receiver 108 is connected to a receiver input (Rx/I) of the signal processing unit 105. A receiver output (Rx/O) of the signal processing unit 105 is connected to an input of a speech decoder (SPD) 110. The input of the speech decoder 110 is also connected to an output of a frame interpolation block (FINT) 109. The output of the speech decoder 110 is connected to an input of a post-filtering block (PF) 111. The output of the post-filtering block 111 is connected to an input of a digital-to-analog (D/A) converter 112. The output of the D/A converter 112 is connected to a loudspeaker 113. Preferably, the SPE 103, FDEC 104, FINT 109, SPD 110 and PF 111 are implemented by means of a digital signal processor (DSP) 114 as is illustrated by the broken line in FIG. 1. If a high degree of integration is desired, the A/D converter 102, the D/A converter 112 and the SPU 105 may also be implemented by means of the DSP 114. It should be understood that the elements implemented by means of the DSP 114 may be realized as software routines run by the DSP 114. However, it would be equally possible to implement these elements by means of hardware solutions. The methods of choosing the actual implementation are well known in the art. The output of the frame decimation block 104 is connected to a controller 115. The controller 115 is also connected to a memory 116, a keyboard 117, a display 118, and a transmit controller (Tx Contr) 119, the Tx Contr 119 being connected to a control input of the transmitter 106. The controller 115 also controls operation of the digital signal processor 114 illustrated by the connection 120 and operation of the signal processing unit 105 illustrated by connection 121 in FIG. 1.

In operation, the microphone 101 picks up an acoustic voice signal and generates thereby a voice signal that is fed to and digitized by the A/D converter 102. The digitized signal is forwarded to the speech encoder 103, which encodes the signal according to a speech encoding algorithm. The signal is thereby compressed and an encoded voice signal is generated.

The encoded voice signal is set in a pre-determined speech encoding format. By compressing the signal the bandwidth of the signal is reduced and, consequently, the bandwidth requirement of a transmission channel for transmitting the signal is also reduced. For example, in the GSM (Global System for Mobile communications) standard a residual pulse-excited long-term prediction (RPE-LTP) coding algorithm is used. This algorithm, which is referred to as a full-rate speech-coder algorithm, provides a compressed data rate of about 13 kilobits per second (kb/s) and is more fully described in GSM Recommendation 6.10 entitled “GSM Full Rate Speech Transcoding”, which description is hereby incorporated by reference. The GSM standard also includes a half-rate speech coder algorithm that provides a compressed data rate of about 5.6 kb/s. Another example is the vector-sum excited linear prediction (VLSELP) coding algorithm, which is used in the Digital-Advanced Mobile Phone Systems (D-AMPS) standard.

It should be understood that the algorithm used by the speech encoder is not crucial to the present invention. Furthermore, the access method used by the communication system is not crucial to the present invention. Examples of access methods that may be used are Code Division Multiple Access (CDMA), Time Division Multiple Access (TDMA), and Frequency Division Multiple Access (FDMA).

The encoded voice signal is fed to the signal processing unit 105, wherein it is further processed before being transmitted as a radio signal using the transmitter 106 and the antenna 107. Certain parameters of the transmitter are controlled by the transmit controller 119, such as, for example, transmission power. The transmit controller 119 is under the control of the controller 115.

The communication apparatus may also receive a radio transmitted encoded voice signal by means of the antenna 107 and the receiver 108. The signal from the receiver 108 is fed to the signal processing unit 105 for processing and a received encoded voice signal is thereby generated.

The received encoded voice signal is coded in the pre-determined speech encoding format mentioned above. The signal processing unit 105 includes, for example, circuitry for digitizing the signal from the receiver, channel coding, channel decoding and interleaving. The received encoded voice signal is decoded by the speech decoder 110 according to a speech decoding algorithm and a decoded voice signal is generated. The speech decoding algorithm represents substantially the inverse to the speech encoding algorithm of the speech encoder 103. In this case the post-filtering block 111 is disabled and the decoded voice signal is output by means of the loudspeaker 113 after being converted to an analog signal by means of the D/A converter 112. The communication apparatus 100 comprises also a keyboard (KeyB) 117 and display (Disp) 118 for allowing a user to give commands to and receive information from the apparatus 100.

If the user wants to store a voice message in the memory 116, the user gives a command to the controller 115 by pressing a pre-defined key or key-sequence at the keyboard 117, possibly guided by a menu system presented on the display 118. A voice message to be stored is then picked up by the microphone 101 and a digitized voice signal is generated by the A/D converter 102. The voice signal is encoded by the speech encoder 103 according to the speech encoding algorithm and an encoded voice signal having the pre-defined speech encoding format is provided. The encoded voice signal is input to the frame decimation block 104, wherein the signal is processed according to a compression algorithm and message data, coded in a pre-determined message data format, is generated. The message data is input to the controller 115, which stores the voice message by writing the message data into the memory 116.

Several exemplary compression algorithms will now be discussed. The encoded voice signal may be considered to comprise a number of data frames, each data frame comprising a pre-determined number of bits. In many systems the concept of data frames and the number of bits per data frame are defined in a communication standard.

A first compression algorithm eliminates i data frames out of j data frames, wherein i and j are integers and j is greater than i. For example, every second data frame may be eliminated.

A second compression algorithm makes use of the fact that in several systems the bits of a data frame are separated into at least two sets of data corresponding to pre-defined priority levels. For example, in a GSM system using the full-rate speech coder algorithm, a data frame is defined as comprising 260 bits, of which 182 are considered to be crucial (highest priority level) and 78 bits are considered to be non-crucial (lowest priority level). The crucial bits are normally protected by a high level of redundancy during radio transmission. The crucial bits will therefore be more insensitive, on a statistical basis, to radio disturbances when compared to the non-crucial bits. The second compression algorithm eliminates the bits of the data frame corresponding to the data set having the lowest priority level (i.e. the non-crucial bits). When the data frame is defined as comprising more than two sets of data corresponding to more than two priority levels, the compression algorithm may eliminate a number of the sets of data corresponding to the lowest priority levels.

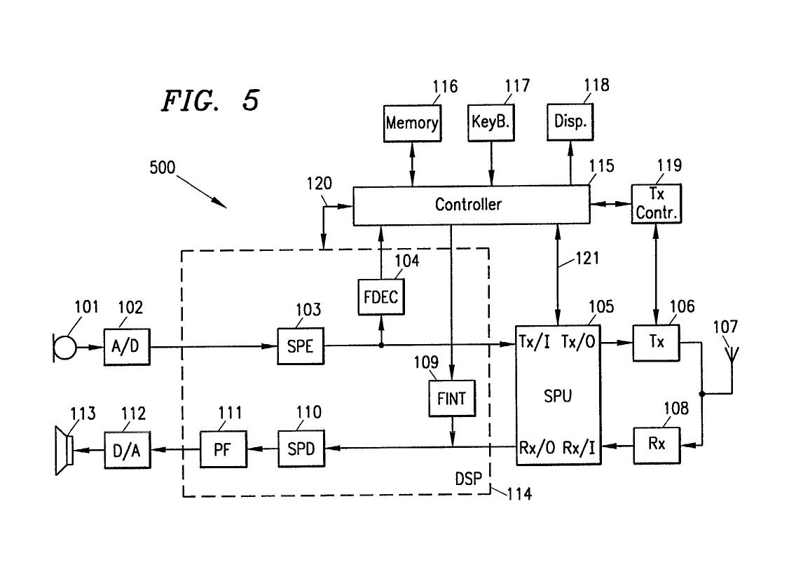

Although some information is lost due to the compression algorithms discussed above, it is normally possible to reconstruct the signal sufficiently well, by the use of a decompression algorithm, to achieve a reasonable quality of the voice message when it is replayed. Exemplary decompression algorithms are discussed below. In addition, a third compression algorithm and decompression algorithm are discussed below with respect to FIGS. 5-14.

When the user wants to retrieve a voice message stored in the memory 116, the user gives a command to the controller 115 by pressing a pre-defined key or key-sequence at the keyboard 117. Message data corresponding to a selected voice message is then read out by the controller 115 and forwarded to the frame interpolation block 109. The decompression algorithm of the frame interpolation block 109 performs substantially the inverse function of the compression algorithm of the frame decimation block.

If message data has been compressed using the first compression algorithm discussed above (wherein i data frames out of j data frames have been eliminated), the corresponding decompression algorithm may reconstruct the eliminated frames by means of an interpolation algorithm (e.g., linear interpolation). Message data compressed according to the second compression algorithm, wherein the bits corresponding to the set of data having the lowest priority level have been eliminated, the corresponding decompression algorithm may replace the eliminated bits by any pre-selected bit pattern. It is preferable, however, that the eliminated bits be replaced by a random code sequence. The random code sequence may either be generated by a random code generator or taken from a stored list of (pseudo-random) sequences.

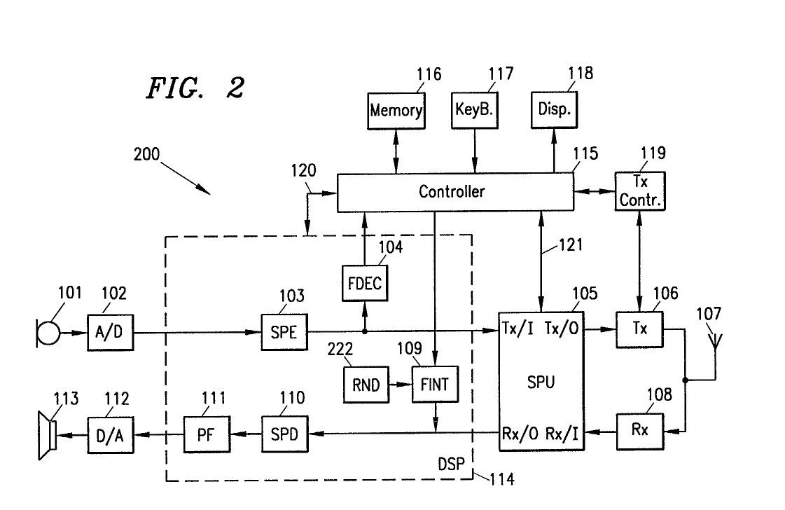

Reference is now made to FIG. 2, wherein there is shown a block diagram of an exemplary communication apparatus 200 in accordance with a second embodiment of the present invention. The second embodiment differs from the first embodiment in that the random code generator (RND) 222 is connected to the frame interpolation block 109. A random code sequence is thereby provided to the frame interpolation block 109.

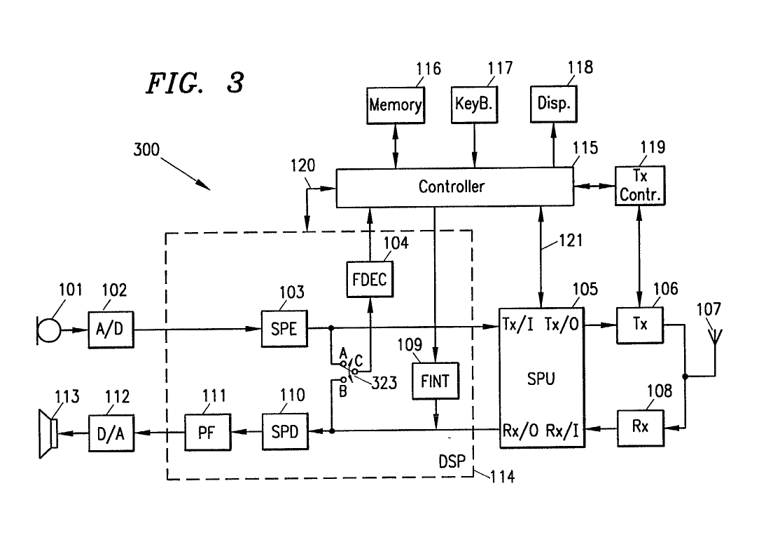

Reference is now made to FIG. 3, wherein there is shown a block diagram of an exemplary communication apparatus 300 in accordance with a third embodiment of the present invention. The third embodiment of the present invention differs from the first embodiment discussed above in that a switch 323 is introduced. The switch 323 has a first terminal A connected to the output of the speech encoder 103, a second terminal B connected to the input of the speech decoder 110, and a common terminal C connected to the input of the frame decimation block 104. The switch may either connect terminal A or terminal B to terminal C upon control by the controller 115.

The operation of the third embodiment is identical to the operation of the first embodiment when the switch 323 connects the output of the speech encoder 103 to the input of the frame decimation block 104 (i.e., terminal A connected to terminal C). However, when the switch 323 connects the input of the speech decoder 110 to the input of the frame decimation block 104 (i.e., terminal B connected to terminal C), the user can store a voice message that is received by the receiver 108. In this case, the encoded voice signal appearing on the input of the speech decoder 110 also appears on the input of the frame decimation block 104. The frame decimation block thereby generates message data coded in the message data format. The controller 115 then stores the message data as a stored voice message in the memory 116. Accordingly, the user may choose to store either a voice message by speaking through the microphone or a voice message received by means of the receiver of the communication device.

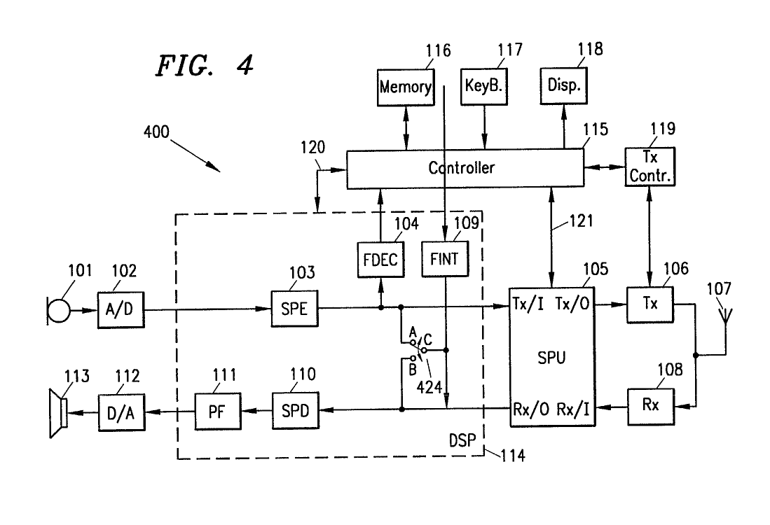

Reference is now made to FIG. 4, wherein there is shown a block diagram of an exemplary communication apparatus 400 in accordance with a fourth embodiment of the present invention. The fourth embodiment of the present invention differs from the first embodiment discussed above in that a switch 424 is introduced. The switch 424 has a first terminal A connected to the output of the speech encoder 103, a second terminal B not connected at all, and a common terminal C connected to the output of the frame interpolation block 109. The switch may either connect terminal A or terminal B to terminal C upon control by the controller 115.

The operation of the fourth embodiment is identical to the operation of the first embodiment when the switch 424 does not connect the output of the frame interpolation block 109 to the transmitter input Tx/I of the signal processing unit 105 (i.e., terminal B connected to terminal C). When the switch 424 does connect the output of the frame interpolation block 109 to the transmitter input Tx/I of the signal processing unit 105 (i.e., terminal A connected to terminal C), the user can retrieve a stored voice message and transmit it by means of the transmitter 106. In this case, message data corresponding to a stored voice message is read out from the memory 116 by the controller 115 and forwarded to the frame interpolation block 109. An encoded voice signal is generated at the output of the frame interpolation block 109 and this signal will, due to the switch 424, also appear on the transmitter input Tx/I of the signal processing unit 105. After processing by the signal processing unit, the voice message is transmitted by means of the transmitter 106. Accordingly, the user may choose to retrieve a stored voice message and either have it replayed through the loudspeaker or in addition have it sent by means of the transmitter.

Referring again to the FIGURES, FIG. 5 illustrates a block diagram of an exemplary communication apparatus 500 and components thereof in accordance with a fifth embodiment of the present invention. The apparatus 500 includes a speech encoder 103 preferably operating according to GSM, that produces a bitstream consisting of different parameters needed to represent speech. This bitstream typically has low redundancy within one frame, but some inter-frame redundancy exists. For example, in a GSM system using the full-rate speech coder algorithm, a data frame is defined as comprising 260 bits, of which 182 bits are considered crucial (highest priority level) and 78 bits are considered non-crucial (lowest priority level). The crucial bits are normally protected by a high level of redundancy during radio transmission. The crucial bits will therefore be more insensitive, on a statistical basis, to radio disturbances when compared to the non-crucial bits. Thus, some of the different parameters have higher interframe redundancy, while other parameters have no interframe redundancy.

The apparatus 500 operates to compress with a lossless algorithm those parameters that have higher interframe redundancy and to compress with a lossy algorithm some or all of those parameters that have lower interframe redundancy. The lossy algorithm and the lossless algorithm are implemented by the FDEC 104 and the FINT 109, respectively. The communication apparatus 500 includes a speech decoder 110 that operates to decompress the speech encoded parameters according to an Algebraic Code Excitation Linear Predictor (ACELP) decoding algorithm.

The speech encoder 103 operates to encode 20 milliseconds (ms) of speech into a single frame. A first portion of the frame includes coefficients of the Linear Predictive (LP) filter that are updated each frame. A second portion of the frame is divided into four subframes; each subframe contains indices to adaptive and fixed codebooks and codebook gains.

Coefficients of a long-term filter (i.e., LP parameters) and of codebook gains have relatively high inter-frame redundancy. Bits representing these parameters (i.e., the bits representing the indices of the LSF submatrices/vectors and the adaptive/fixed codebook gains are compressed with a lossless algorithm. An example of a lossless algorithm is the Context Tree Weighting (CTW) Method having a depth D.

Indices to the fixed codebook represent the excitation vector of the LP filter. These parameters are denoted “position of i:th pulse,” i=1:10 for the Enhanced Full Rate (EFR) codec. Position of the i:th pulse i=1:2 for the Adaptive Multi-Rate (AMR) 4.75 kbps mode codec. These parameters are noise-like and show no redundancy. However, they are not as important as the rest of the parameters. Thus, a lossy compression algorithm can be used. The fixed codebook index in subframe 1 of each frame is copied to subframes 2, 3, 4 in the same frame. In addition, the fixed codebook index in subframe 1 is only updated every n:th frame. In other words, the fixed codebook index from subframe 1 in a frame k is copied to all positions for the fixed codebook index for the next n frames. In frame k+n, a new fixed codebook index is used.

The parameters representing pitch frequencies and bits representing signs need not be compressed at all. They have a low redundancy, which indicates that a lossless scheme would not work, but because they are very important for speech quality, a lossy scheme should not be used.

Speech quality resulting from lossy compression in FINT 109 can be improved by changing weighting factors in a format postfilter and a tilt factor in a tilt compensation filter in the EFR and AMR codecs (these two filters are denoted by post filter 111 in the speech decoder 110). This can be achieved by calculating short-time fourier transforms (STFT) of both: 1) a de-compressed speech signal and 2) a corresponding speech signal without any manipulations and then changing the weighting factors of the de-compressed signal until a minimum in the difference of the absolute value of the STFT between the two speech signals is achieved. In addition or in the alternative, a subjective listening test can be performed. These two tests often yield the same result: γₙ=0.25, γ_{d}=0.75 and μ=0.75 for optimal speech quality. These values are slightly different from the values given in GSM 06.60 (March 1997) and GSM 06.90 (February 1999). It should be understood that the particular algorithm used by the speech encoder 103 and speech decoder 110 is not crucial to this aspect of the present invention.

An advantage of the present invention is that the apparatus 500 effectively compresses the bitstream before it is stored in the memory 116 and thereby enables an increase in storage capacity of mobile voice-storage systems. Another advantage of the present invention is that the apparatus 500 effectively eliminates the need for a tandem connection of different speech codecs. Moreover, the apparatus 500 has low implementation complexity.

The technology within apparatus 500 is applicable to EFR-based and AMR-based digital mobile telephones. In addition, the technology within the apparatus 500 can be incorporated within the different embodiments of the apparatus disclosed in this application, including the apparatuses 100, 300 and 400.

Statistical Analysis

In the Background, parameters produced by the EFR and AMR speech encoders were described. In addition to encoding the parameters, an encoder also multiplexes the parameters into frames before sending the parameters to a channel encoder. Therefore, bit allocation is of fundamental importance if a statistical analysis is to be performed in order to determine which parameters should be compressed using lossy and lossless algorithms and which parameters should not be compressed at all.

EFR Correlation

The first natural step in analyzing data to be compressed is to determine the correlation between frames. Unfortunately, the bitstream includes different codebook indices and not “natural” data. To be able to find the correlation between, for example, the fixed codebook gains in different frames, their indices would have to be looked up in the codebook and then the correlation between the looked-up values computed. For most of the parameters, it would be necessary to go two or three steps back in the encoding process to be able to compute the “real” correlation. Since the parameters are indices of different vector quantizer tables, the best way to compute the correlation of the parameters would be to use the Hamming weight (d_{H}) between the parameters in two frames or between two parameters in the same frame.

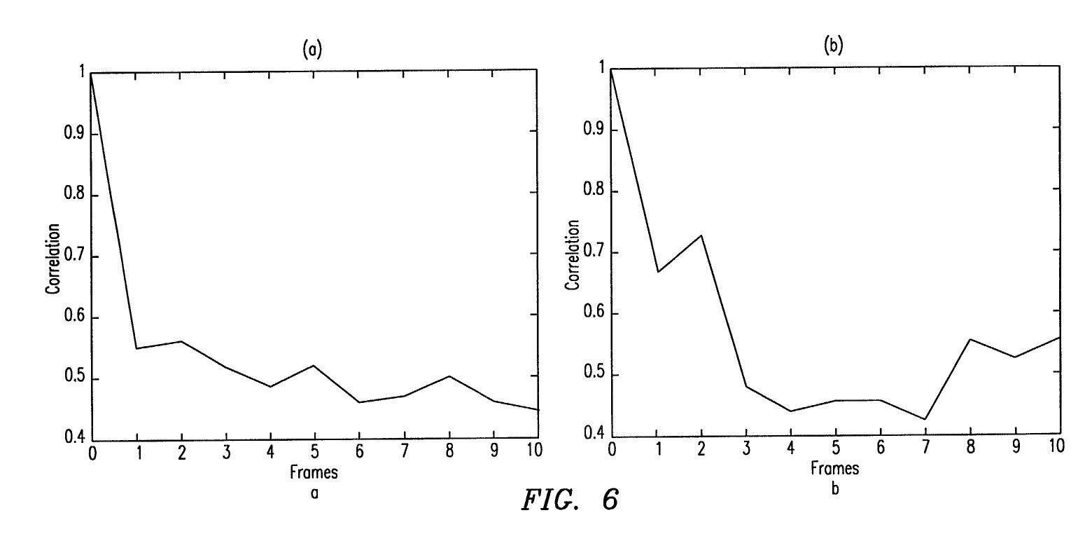

Reference is now made to FIG. 6, wherein there is shown an exemplary normalized correlation between a typical frame and ten successive frames for an entire frame and for LSF parameters. FIG. 6a shows correlation for the entire frame, while FIG. 6b shows correlation for the LSF parameters only. If F denotes a matrix representation of encoded speech, F is built up by frames or column vectors (f), each with 244 bits, for the EFR codec. Now, consider frame i, corresponding to vector fᵢ. The normalized correlation using the Hamming distance between a typical frame fᵢ and successive frames fⱼ, j=i, i+1, . . . , i+10 is depicted in FIG. 6a. Thus, the correlation between frame i and frames i+1 and i+2 is highest, as expected. The correlation is computed for all of the frames. A higher correlation is found if a fewer number of bits are taken into consideration, for example, bits 1-38 (i.e., the LSF parameters), as shown in FIG. 6b. Although the speech encoder ideally encodes speech into frames that contain very little redundancy, some correlation between different subframes within each frame can nonetheless be found.

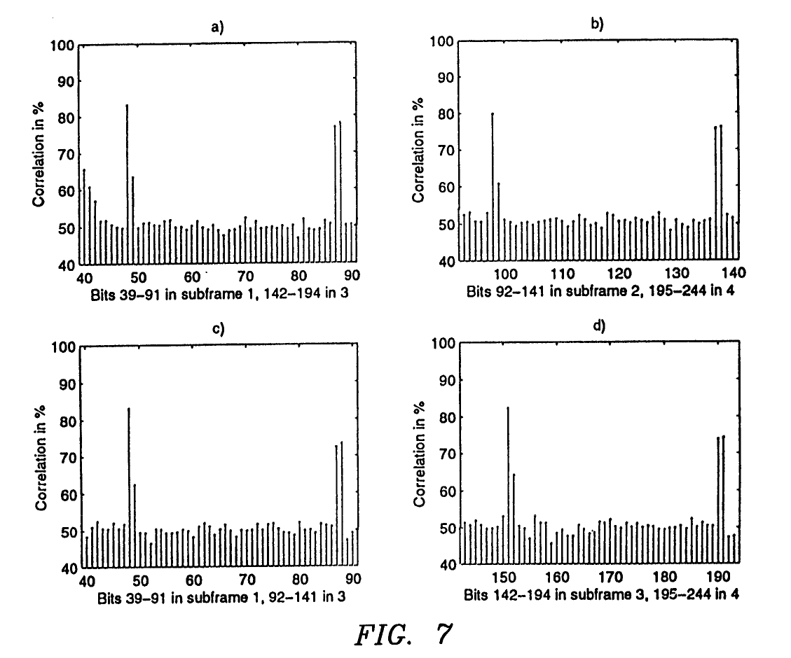

Reference is now made to FIG. 7, wherein there is shown exemplary normalized correlation between EFR subframes 1 and 3 (FIG. 7a), 2 and 4 (FIG. 7b), 1 and 2 (FIG. 7c), and 3 and 4 (FIG. 7d). For example, FIG. 7a shows that the correlation between bit 48 in subframe 1 and bit 151 in subframe 3 is approximately 80-90%. Thus, the highest intra-frame correlation can be found in the bits corresponding to the indices for the adaptive codebook gain and the fixed codebook gain, respectively.

EFR Entropy Measurements

The second step in the statistical analysis is to take entropy measurements of selected parameters. Entropy of a stochastic variable X is defined as:

$$H ( X ) = - {\sum }_{i = 1}^{L} P ( X = {x}_{i} ) \cdot log P ( X = {x}_{i} ) , \qquad ( 18 )$$

wherein 0<P(X=xᵢ)≦1. This measurement can be interpreted as the uncertainty of X, or the average self-information that an observation of X can provide, wherein the convention log(z)=log₂(z) is used. This quantity represents the minimum average number of bits needed to represent a source letter accurately. If X is in the set {x1, x2, . . . , x_{L}}, it can be shown that H(X) is bounded by:

0≦H(X)≦logL. (19)

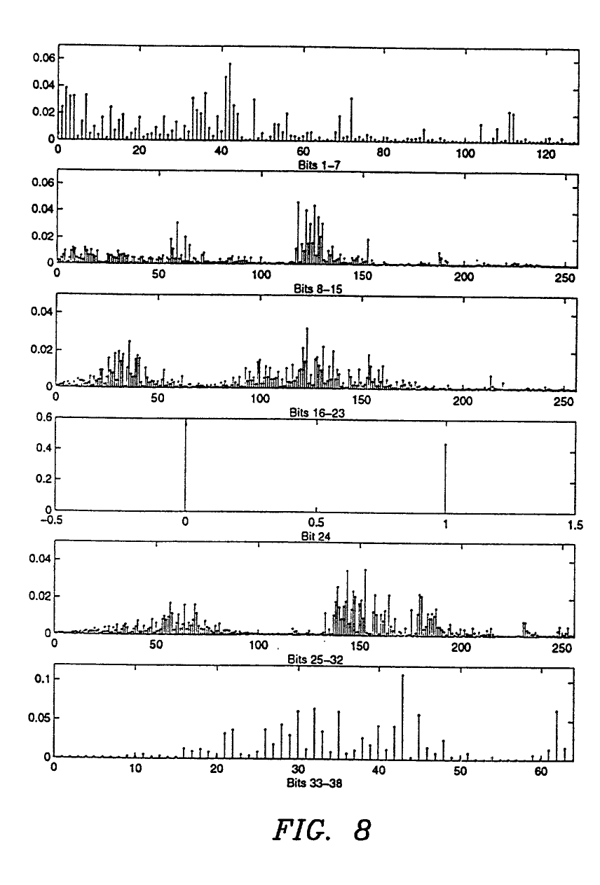

Reference is now made to FIG. 8, wherein there is shown an exemplary probability distribution of values of LSF parameters of an EFR codec from an exemplary speech segment of 7 minutes. The non-uniform distribution of the values indicates that some kind of re-coding of the parameters is possible in order to achieve a lower bit rate.

Unconditional entropy of the bitstream is calculated on a frame basis using equation 18. First, bits of the desired parameters in the frames are converted to decimal numbers. If the results from the inter-frame correlation measurements are used, the most interesting parameters to analyze are the LSF parameters, the adaptive codebook index and gain, and the fixed codebook gain. These parameters are selected from subframe 1 and in addition, the relative adaptive codebook gain, the adaptive and fixed codebook gains from subframe 2 are analyzed. The entropy of the first five pulses of subframe 1 (a total of 30 bits) is also calculated to confirm that no coding gain can be achieved from these parameters.

Table 3 shows a summary of the resulting entropy calculations. Results for the individual parameters are shown in Table 4.

TABLE 3
Summary of unconditional entropy measurements for EFR codec

| Parameter | # bits | U. Entropy | Σ U. Entropy |
|---|---|---|---|
| LSF | 37 | 32.3 | 91.3 |
| Subframe 1 | 48 | 45.9 | |
| Subframe 2 | 15 | 13.1 | |

TABLE 4
Results from entropy measurements for EFR codec

| Parameter | # bits | U. Entropy | C. Entropy |
|---|---|---|---|
| LSF Parameters | | | |
| index of 1st LSF submatrix | 7 | 5.9 | 5.2 |
| index of 2nd LSF submatrix | 8 | 7.0 | 6.2 |
| index of 3rd LSF submatrix | 8 | 7.1 | 6.7 |
| index of 4th LSF submatrix | 8 | 7.1 | 6.6 |
| index of 5th LSF submatrix | 6 | 5.2 | 2.9 |
| Subframe 1 | | | |
| adaptive codebook index | 9 | 8.9 | 7.3 |
| adaptive codebook gain | 4 | 3.8 | 3.6 |
| position of 1st pulse | 6 | 5.9 | 5.8 |
| position of 2nd pulse | 6 | 5.9 | 5.8 |
| position of 3rd pulse | 6 | 5.9 | 5.8 |
| position of 4th pulse | 6 | 5.9 | 5.8 |
| position of 5th pulse | 6 | 5.9 | 5.8 |
| fixed codebook gain | 5 | 3.7 | 3.2 |
| Subframe 2 | | | |
| adaptive codebook index (relative) | 6 | 5.6 | 5.5 |
| adaptive codebook gain | 4 | 3.7 | 3.6 |
| fixed codebook gain | 5 | 3.7 | 3.5 |
| Total | 100 | 91.3 | 83.8 |

Conditional entropy of the selected parameters is calculated using the following equation:

$$\begin{matrix}H ( {X}_{n} \vert {X}_{n - 1} ) = - {\sum }_{i , j} P ( {X}_{n} = {x}_{i} , {X}_{n - 1} = {x}_{j} ) \cdot \\ log P ( {X}_{n} = {x}_{i} \vert {X}_{n - 1} = {x}_{j} ) ,\end{matrix} \qquad ( 20 )$$

wherein P(Xₙ=χᵢ|Xₙ₋₁=χⱼ) is calculated from the matrix using the equation:

$$p ( i \vert j ) = \frac{p ( i , j )}{p ( j )} = \frac{p ( i , j )}{{\sum }_{i} p ( i , j )} . \qquad ( 21 )$$

Equation 20 represents the average of the entropy of Xₙ₋₁ for each value in Xₙ, weighted according to the probability of obtaining that particular χ. For each parameter with N_{b} bits, a matrix of size 2N_{b}×2N_{b} is needed. The value of an element (i,j) in the matrix corresponds to the total number of transitions from the parameter value i (converted to a decimal number) at time k to the parameter value j at time k+1 for k=1, 3, . . . , F−2, wherein F is the number of frames analyzed. The matrix is converted into a probability matrix by dividing all elements by a factor of

$$\frac{1}{2} \cdot F .$$

Then, the entropy is calculated using equation 20.

The conditional entropy procedure is repeated for all the desired parameters. The overall results are presented in Table 5. A more detailed description of the individual parameters is shown in Table 4.

TABLE 5
Summary of conditional entropy measurements for EFR codec

| Parameter | # bits | C. Entropy | π C. Entropy |
|---|---|---|---|
| LSF | 37 | 27.7 | 83.8 |
| Subframe 1 | 48 | 43.5 | |
| Subframe 2 | 15 | 12.6 | |

The results shown in Table 4 represent an exemplary simulation containing approximately four hours of speech. A general rule of thumb is that each element in a probability matrix should have a chance of getting “hit” 10 times. This yields a total of 29·29·10·2·20·10⁻³/60/60≈30 hours of speech for a 9-bit parameter (e.g., adaptive codebook index). If only 5.5 “hits” are needed, the results are valid for parameters with ≦8 bits. However, the difference between a simulation of 1 hour and 4 hours of speech is small (e.g., the entropy value of the 9 bit parameter changes by only 10%).

Entropy Measurements for AMR 4.75 kbps mode

The same conditional and unconditional entropy measurements applied to the EFR codec are applied to the AMR 4.75 kbps mode codec. The LSF parameters, adaptive codebook index in subframe 1, relative adaptive codebook indices in subframes 2-4, and codebook gains in subframes 1 and 3 are analyzed.

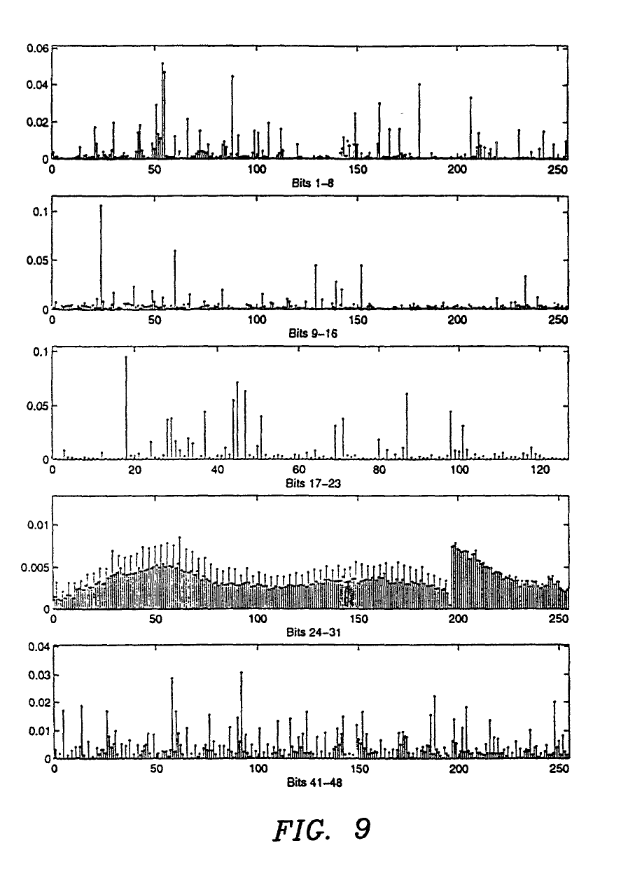

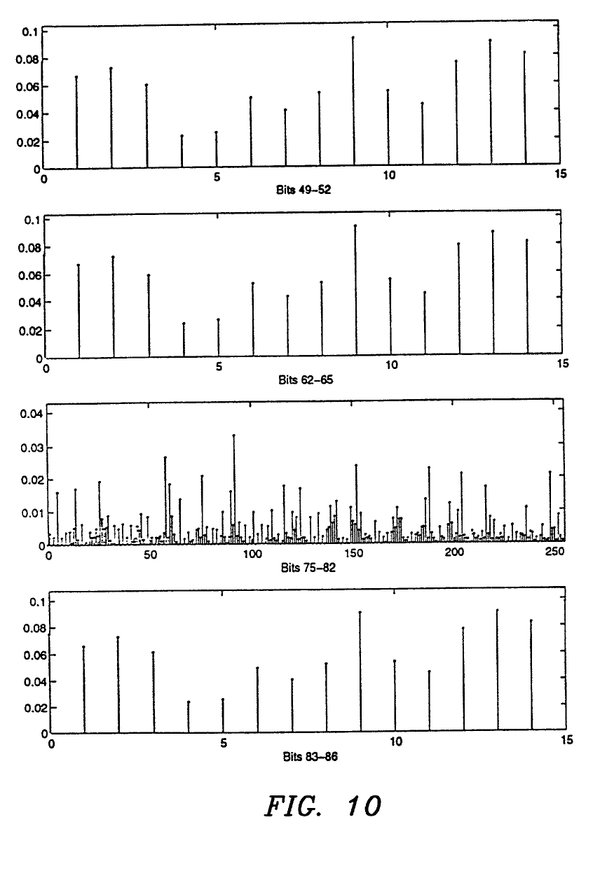

Referring again to the FIGURES, FIGS. 9 and 10 show exemplary distributions of corresponding decimal values for the analyzed parameters. FIG. 9 shows an exemplary probability distribution of bits 1-8, 9-16, 17-23, 24-31, and 41-48 for the AMR 4.75 kbps mode. FIG. 10 shows an exemplary probability distribution of bits 49-52, 62-65, 75-82, and 83-86 for the AMR 4.75 kbps mode. As in the EFR case, the distribution is skewed, which indicates that some coding gain can be achieved. Exemplary simulation results from the entropy calculations shown in Table 6 also indicate that coding gain is achievable.

TABLE 6
Results from entropy measurements for AMR 4.75 kbps mode codec

| Parameter | # bits | U. Entropy | C. Entropy |
|---|---|---|---|
| LSF Parameters | | | |
| index of 1st LSF subvector | 8 | 6.3 | 4.8 |
| index of 2nd LSF subvector | 8 | 6.4 | 5.0 |
| index of 3rd LSF subvector | 7 | 5.3 | 4.5 |
| Subframe 1 | | | |
| adaptive codebook index | 8 | 7.9 | 6.7 |
| Codebook gains | 8 | 7.1 | 6.2 |
| Subframe 2 | | | |
| adaptive codebook index (relative) | 4 | 3.9 | 3.9 |
| Subframe 3 | | | |
| adaptive codebook index (relative) | 4 | 3.9 | 3.9 |
| Codebook gains | 8 | 7.1 | 6.1 |
| Subframe 4 | | | |
| adaptive codebook index (relative) | 4 | 3.9 | 3.9 |
| Total | 59 | 51.9 | 44.8 |

Lossy Data Compression

Results from the statistical analysis are utilized in accordance with the present invention to manipulate the bitstream (i.e., the frames) produced by the speech encoder in order to further compress the data. Data compression is of two principal types: lossy and lossless. Three major factors are taken in consideration in designing a compression scheme, namely, protected-unprotected bits, subframe correlation, and entropy rates.

In some applications, a loss of information due to compression can be accepted. This is referred to as lossy compression. In lossy compression, an exact reproduction of the compressed data is not possible because the compression results in a loss of some of the data. For example, in a given lossy compression algorithm, only certain selected frame parameters produced by the speech encoder would be copied from one subframe to another before sending the bit stream to the memory. Lossy compression could also be accomplished by, for example, updating some but not all of the parameters on a per frame basis.

There are two main approaches when applying lossy compression to a bitstream consisting of different parameters. A first approach is to store certain parameters in only one or two subframes in each frame and then copy those parameters to the remaining subframes. A second approach is to update certain parameters every nth frame. In other words, the parameters are stored once every nth frame and, during decoding, the stored parameters are copied into the remaining n−1 frames. A determination is made of the number of frames in which the parameters are not updated that still yields an acceptable speech quality. A combination of the approaches described above can also be used.

Lossy compression approaches that result in files with acceptable speech quality will now be described, in which:

N=Total number of bits in each frame, (N=244, for the EFR case and N=95 for the AMR 4.75 kbps mode);

p=Number of bits for the pulses in each subframe, pε{30, 6};

R_{B}=Bit rate before compression, RBε{12.2, 4.75} kbps; and

R_{A}=Bit rate after compression.

Four different exemplary lossy compression methods are described below:

1. In every frame, innovation vector pulses (i.e. the bits representing positions of pulses) from subframe 1 are copied to subframe 3 and pulses from subframe 2 are copied to subframe 4. This method is designated lossy method 1 and the bit rate can be calculated as:

$${R}_{A} = ( N - 2 p ) \cdot \frac{{R}_{B}}{N} . \qquad ( 22 )$$

2. In every frame, innovation vector pulses from subframe 1 are copied to subframes 2-4 (lossy method 2):

$${R}_{A} = ( N - 3 p ) \cdot \frac{{R}_{B}}{N} \cdot \qquad ( 23 )$$

3. As in lossy method 2 but in addition, the pulses in subframe 1 are only updated every 2nd frame (lossy method 3):

$${R}_{A} = \frac{( N - 4 p ) + ( N - 3 p )}{2} \cdot \frac{{R}_{B}}{N} . \qquad ( 24 )$$

4. As in lossy method 3 but the pulses in subframe 1 are only updated every n:th frame (lossy method 4):

$${R}_{A} = \frac{( N - 4 p ) \cdot ( n - 1 ) + ( N - 3 p )}{n} \cdot \frac{{R}_{B}}{N} . \qquad ( 25 )$$

Lossy methods 1-4 are presented for illustrative purposes. It will be understood by those skilled in the art that other lossy methods could be developed in accordance with the present invention.

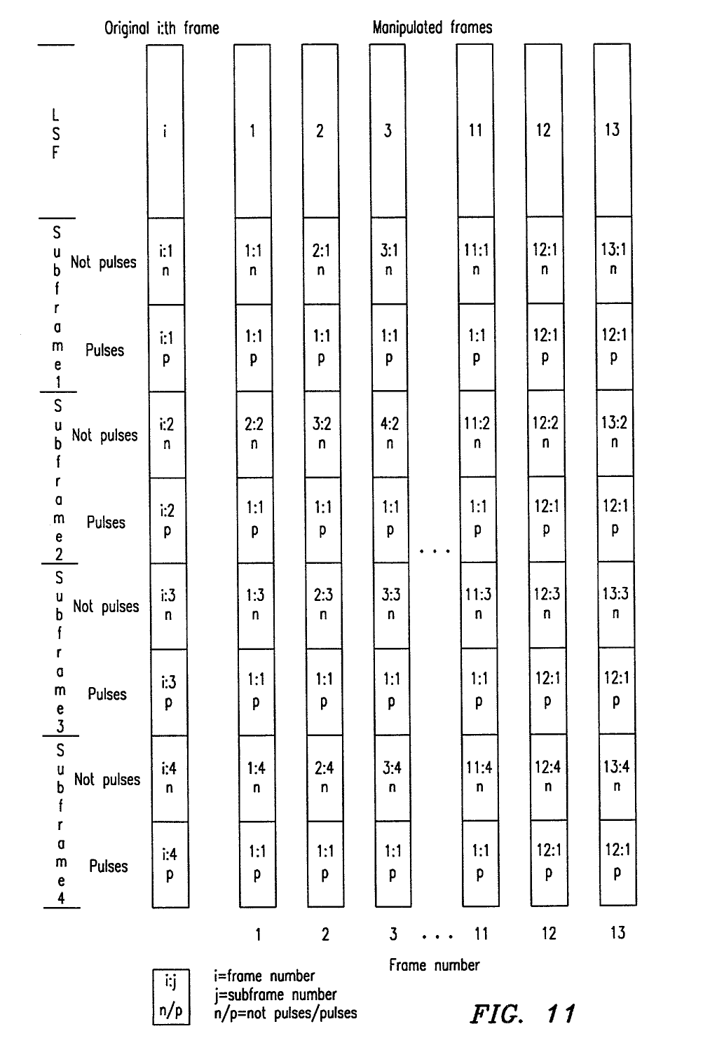

Referring again to the FIGURES, FIG. 11 illustrates an exemplary lossy compression by bit manipulation according to lossy method 4. In lossy method 4, the innovation vector pulses from subframe 1 are copied to subframes 2-4, and the pulses in subframe 1 are only updated every nth frame. LSF parameters are updated every frame. Since n=12 in FIG. 11, a plurality of frames i, 1-3, and 11-13 are shown. Frames 4-10, although not explicitly shown, are manipulated in the same fashion as described herein. The frame i is the original frame and the frames 1-3 and 11-13 are manipulated frames. Each of the frames i, 1-3, and 11-13 includes subframes 1-4. Each of the subframes 1-4 of each of the frames i, 1-3, and 11-13 comprises a not pulses portion and a pulses portion. In accordance with lossy method 4, the pulses portion of the subframe 1 of the frame 1 is copied to the subframes 2-4 of the frame 1.

The pulses portion of the subframe 1 that has been copied to the subframes 2-4 in the frame 1 is not updated until the frame 12, such that the pulses portions of the subframes 1-4 are identical in each of the frames 1-11. At the frame 12, the pulses portion of the subframe 1 is updated and is copied to the pulses portion of the subframes 2-4. At the frame 13, the pulses portion of each of the subframes 2-4 is not updated as described above.

In Table 7, corresponding bit rates resulting from the bit-manipulating strategies of lossy methods 1-4 are listed. For lossy method 4, n=12 is used.

TABLE 7
Corresponding bit rates (in bits per second) from lossy methods 1-4

| Method | Bit rate for EFR | Bit rate for AMR |
|---|---|---|
| Original | 12200 | 4750 |
| 1 | 9200 | 4150 |
| 2 | 7700 | 3850 |
| 3 | 6950 | 3700 |
| 4 | 6325 | 3575 |

Speech Quality Improvements

A method to improve speech quality after lossy compression involves changing the weighting factors in the formant post-filter of equation 14 (e.g. PF 111) and the tilt factor of equation 15. Short Time Fourier Transforms (STFT) of the speech signals are calculated before and after manipulation and the values of γₙ, γ_{d} and μ are changed until a minimum in the differences of the absolute values of the Fourier Transforms is achieved. The Fourier Transforms are best calculated on a frame basis. This can be accomplished by applying a Short-Time Fourier Transform (STFT) to 20 ms·8 kHz=160 samples at a time. The STFT is defined as

$$\begin{matrix}X [ k , {m}_{1} ] = {\sum }_{n = {m}_{1} - N + 1}^{{m}_{l}} ( w ( n - {m}_{l} ) \cdot x ( n ) ) {ⅇ}^{- j ( 2 π / N ) kn} , k = 1 , 2 , … N , & ( 26 ) \\ i = 1 , 2 , … , F & \end{matrix}$$

wherein k is the frequency vector, F the number of frames analyzed, and w is a window of order L. The STFT is a two-dimensional valued variable and can be interpreted as the local Fourier Transform of the signal x(n) at time (i.e., frame) mᵢ. The STFT of the original signal (with no bit manipulation) is compared with bit-manipulated speech signals with various values of γₙ, γ_{d} and μ used in the post process.

Exemplary simulations are performed with different values of γₙ, γ_{d} and μ both on manipulated speech originating from the EFR and from the AMR 4.75 kbps mode codecs. A listening test reveals that the values γₙ≈0.25, γ_{d}≈0.75 and μ≈0.75 provide the best speech quality. Computation of the corresponding |STFT(x(n)_{original})−(STFT(x(n)_{manipulated})| for the different manipulated speech files confirms this result.

Lossless Data Compression

While some loss of information inevitably occurs when a lossy compression scheme is employed, an exact reproduction of data is possible if a lossless compression algorithm is used. Some lossless algorithms use knowledge about the probability density of input data. Other lossless algorithms work directly on observed input data. The second type is often referred to as “universal coding.” Application of several well-known coding schemes has revealed that bitstreams from speech encoders contain very little redundancy. The similarity between two consecutive frames is very small, but if one parameter at a time is considered, similarity between consecutive frames increases. In an analysis of lossless methods in accordance with the present invention, an incoming bitstream is first divided into a single bitstream for each parameter, and then a compression algorithm is applied individually to each parameter.

Context Tree Weighting Algorithm

A first lossless compression scheme uses Context Tree Weighting (CTW), which is used in accordance with the present invention to find a distribution that minimizes codeword length. CTW utilizes the fact that each new source symbol is dependent on the most recently sent symbol(s). This kind of source is termed a tree source.

A context of the source symbol u is defined as the path in the tree starting in the root and ending in a leaf denoted “s,” which is determined by symbols proceeding u in the source sequence. Thus, the context is a suffix of u. The tree is built up by a set “S” of suffixes. The set S is also called a model of the tree. To each suffix leaf in the tree there exists a parameter θₛ, which specifies the probability distribution over the symbol alphabet. Thus, the probability of the next symbol being 1 depends on the suffix of S of the past sequence of length D, wherein D is the depth of the tree. The empty string, which is a suffix to all strings, is denoted λ.

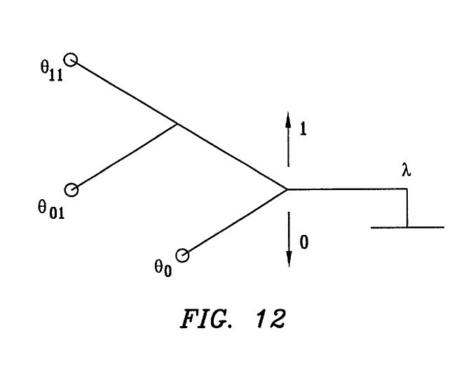

Reference is now made to FIG. 12, wherein there is shown an exemplary context tree with depth D=2. An empty string λ is shown. Parameters θ₀, θ₀₁, and θ₁₁ are also shown. Therefore, θ₀ represents the probability that a first symbol is 0, θ₀₁ represents the probability that the first symbol is 0 and a second symbol is 1, and θ₁₁ represents the probability that the first symbol and the second symbol are both 1.

A context tree can be used to compute an appropriate coding distribution if the actual model of the source is unknown. To obtain a probability distribution, the number of ones and zeros are stored in the nodes as a pair (aₛ,bₛ). Given these counts, the distribution for each model can be found. For example, if the depth of the tree is 1, only two models exist; a memory-less source with the estimated mass function Pₑ(a_{λ},b_{λ}) and a Markov source of order one, with the mass function Pₑ(a₀,b₀)Pₑ(a₁,b₁). Thus, the weighted distribution of the root can be written as:

$${P}_{ω} = \frac{{P}_{e} ( {a}_{λ} , {b}_{λ} ) + {P}_{e} ( {a}_{0} , {b}_{0} ) {P}_{e} ( {a}_{1} , {b}_{1} )}{2} \qquad ( 27 )$$

From this distribution an arithmetic encoder produces codewords. The corresponding decoder reconstructs the sequence from the codewords by computation.

Tables 8 and 9 show average codeword lengths for parameters compressed with the CTW method with depth D=1 for EFR and AMR 4.75 kbps codecs based on exemplary simulations performed on 30, 60 and 90 second sample s of speech.

TABLE 8
Average codeword length when CTW compression method is applied
on parameters encoded by EFR encoder.

| Parameter | Bits | 30 s. | 60 s. | 90 s. |
|---|---|---|---|---|
| LSF Parameters | | | | |
| index of 1st LSF submatrix | 7 | 5.6 | 5.3 | 5.3 |
| index of 2nd LSF submatrix | 8 | 6.0 | 5.8 | 5.6 |
| index of 3rd LSF submatrix | 8 | 6.6 | 6.5 | 6.4 |
| index of 4st LSF submatrix | 8 | 6.2 | 6.0 | 5.9 |
| index of 5th LSF submatrix | 6 | 4.6 | 4.5 | 4.4 |
| Subframe 1 | | | | |
| adaptive codebook gain | 4 | 3.2 | 3.2 | 3.2 |
| fixed codebook gain | 5 | 2.7 | 2.6 | 2.7 |
| Subframe 2 | | | | |
| adaptive codebook gain | 4 | 3.1 | 3.1 | 3.0 |
| fixed codebook gain | 5 | 2.7 | 2.6 | 2.6 |
| Total | 55 | 40.7 | 39.6 | 39.0 |

TABLE 9
Average codeword length when CTW is applied on parameters
encoded by AMR 4.75 kbps mode.

| Parameter | Bits | 30 s. | 60 s. | 90 s. |
|---|---|---|---|---|
| LSF Parameters | | | | |
| index of 1st LSF subvector | 8 | 6.0 | 5.7 | 5.6 |
| index of 2nd LSF subvector | 8 | 5.5 | 5.3 | 5.2 |
| index of 3rd LSF subvector | 7 | 4.4 | 4.2 | 4.1 |
| Subframe 1 | | | | |
| adaptive codebook index | 8 | 8.0 | 7.9 | 7.8 |
| Codebook gains | 8 | 6.2 | 6.1 | 6.0 |
| Subframe 2 | | | | |
| Codebook gains | 8 | 6.2 | 5.9 | 5.9 |
| Total | 47 | 36.1 | 35.1 | 34.5 |

Move-to-Front Algorithm

Another algorithm that can be used for lossless compression of high-redundancy parameters is commonly referred to as the Move-to-Front (MTF) algorithm. The parameters are placed in a list and then sorted so that the most probable parameter is in a first position in the list. The sorted list is stored in both the encoder and the decoder prior to compression. It is assumed that the parameter to be compressed is the most probable parameter. The algorithm searches for this parameter in the list, sends its position (also called the “backtracking depth”) to the decoder and then puts that parameter in the first place in the list. The decoder, having the original list and receiving the information about the parameter position, decodes the parameter and puts the decoded parameter in the first position in the list.

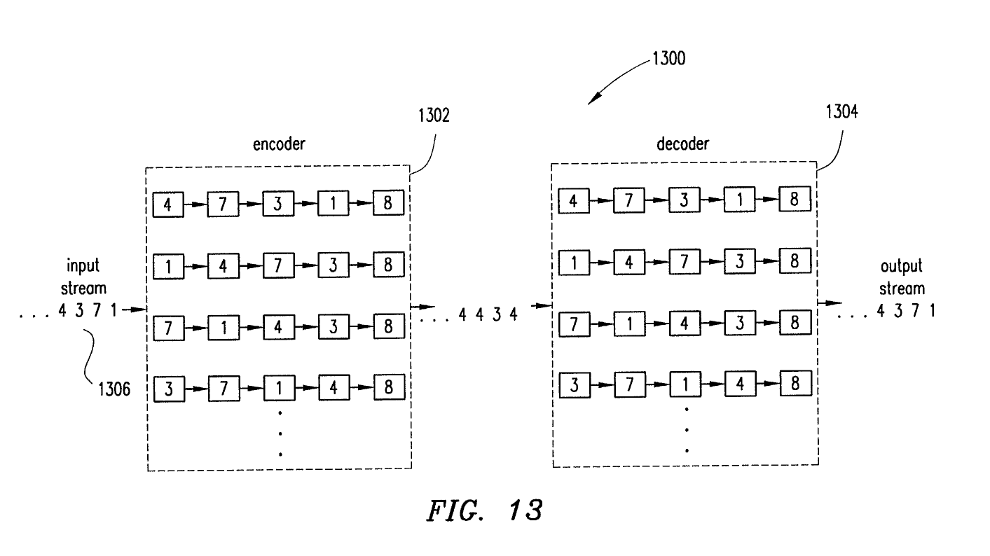

Reference is now made to FIG. 13, wherein there is shown exemplary encoding and decoding 1300 according to the MTF method. In FIG. 13, an encoder 1302 and a decoder 1304 operating according to the MTF method are shown. The encoder 1302 receives an input bit stream 1306 comprising parameters 4, 3, 7, 1. Both the encoder 1302 and the decoder 1304 have a stored list that has been stored before compression occurs. Upon receipt of the parameters 4, 3, 7, 1, the encoder 1302 searches the list sequentially for each of the parameters. The first parameter, 1, is found at a position 4 in a first row of the list, so the parameter 1 is encoded as 4. The second parameter 7 is found at a position 3 of a second row of the list, so the parameter 7 is encoded 4. A similar process occurs for the parameters 3 and 4. Upon receipt, the decoder 1304 performs the reverse function of the encoder 1302 by searching the list based on the positions received from the encoder 1302.

The MTF algorithm performs well if the input data sometimes oscillates between only a few values or is stationary for a few samples. This is often the case with input speech data. The probability distribution for the backtracking depth in the list is calculated from a large amount of data and the positions are Huffman encoded. The mapping tables are stored in both the encoder and the decoder.

Using the MTF scheme on high-redundancy parameters in the EFR and the AMR 4.75 kbps mode achieves some compression. Four hours of speech have been used to calculate the probability distribution for the backtracking depth in the list. Following calculation of the probability distribution, the data were Huffman encoded. The same four hours were used to calculate the probability distribution for the parameters in the input stream so that list could be sorted. The backtracking depth for the parameter currently compressed is encoded with a Huffman code, which is calculated from the distribution. The average lengths of the parameters after encoding are listed in Tables 10-11.

The major disadvantage of the MTF scheme is that a number of mapping tables must be stored, which for Huffman codes can take a considerable amount of memory. Instead of a Huffman code, Minimum-Redundancy Prefix Codes that have equally good average word lengths, but smaller computational complexity and memory usage, could be used.

In Tables 10 and 11, the average codeword lengths for the parameters compressed with the Move-to-Front scheme for EFR and AMR 4.75 kbps for 30, 60, and 90 seconds of speech are shown. With this scheme, no compression can be achieved on the adaptive codebook gains for EFR or on the adaptive codebook index for the AMR case, so these parameters are preferably not included when using the MTF algorithm.

TABLE 10
Average codeword length when Move-To-Front compression
method is applied on parameters encoded by EFR encoder

| Parameter | Bits | 30 s. | 60 s. | 90 s. |
|---|---|---|---|---|
| LSF Parameters | | | | |
| index of 1st LSF submatrix | 7 | 6.1 | 6.1 | 6.1 |
| index of 2nd LSF submatrix | 8 | 6.8 | 6.7 | 6.7 |
| index of 3rd LSF submatrix | 8 | 7.0 | 7.0 | 6.9 |
| index of 4th LSF submatrix | 8 | 6.8 | 6.8 | 6.7 |
| index of 5th LSF submatrix | 6 | 5.2 | 5.2 | 5.1 |
| Subframe 1 | | | | |
| fixed codebook gain | 5 | 3.2 | 3.2 | 3.2 |
| Subframe 2 | | | | |
| fixed codebook gain | 5 | 3.2 | 3.2 | 3.2 |
| Total | 47 | 38.4 | 38.1 | 37.9 |

TABLE 11
Average codeword length when Move-To-Front method is applied
to parameters encoded by AMR 4.75 kbps mode

| Parameter | Bits | 30 s. | 60 s. | 90 s. |
|---|---|---|---|---|
| LSF Parameters | | | | |
| index of 1st LSF subvector | 8 | 6.4 | 6.4 | 6.3 |
| index of 2nd LSF subvector | 8 | 6.2 | 6.2 | 6.2 |
| index of 3rd LSF subvector | 7 | 5.1 | 5.1 | 5.1 |
| Subframe 1 | | | | |
| Codebook gains | 8 | 6.9 | 6.9 | 6.9 |
| Subframe 2 | | | | |
| Codebook gains | 8 | 6.9 | 6.9 | 6.9 |
| Total | 39 | 31.6 | 31.5 | 31.2 |

Results

The lossy and lossless compression schemes can be combined in accordance with the present invention to form a combined compression scheme. The output bitstream from the speech encoder is first divided into three classes: lossless; lossy; and uncompressed. All pulses (i.e., innovation vector pulses) are compressed a lossy compression method such as, for example, lossy method 4. For the parameters compressed in a lossless manner, a separate compression scheme is applied to the individual parameters. It is preferable that no compression is performed on bits representing the adaptive codebook indices or the bits representing signs. The total number of bits transmitted to the memory after combined lossy and lossless compression, B_{A}, can be written as:

$${B}_{A} = \frac{( N - D - 4 p ) \cdot ( n - 1 ) + ( N - D - 3 p )}{n} \qquad ( 28 )$$

wherein D is the total number of bits that are losslessly compressed in each frame. In the exemplary simulations, n=12 is used. Since a new frame is sent every 20 ms, the bit rate can be calculated as

$${R}_{A} = \frac{{B}_{A}}{0.02} .$$

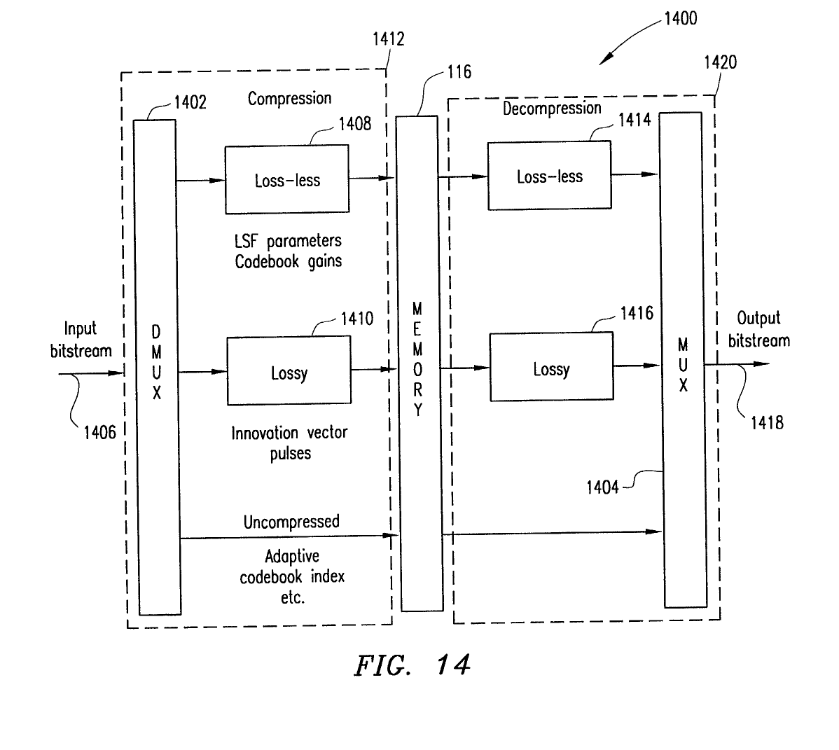

Reference is now made to FIG. 14, wherein there is shown a block diagram of an exemplary complete compression system 1400. The system 1400 includes a demultiplexer (DMUX) 1402, the memory 116, and a multiplexer (MUX) 1404. An input bit stream is received by the DMUX 1402. The DMUX 1402 demultiplexes parameters of an input bit stream 1406 into losslessly-compressed, lossy-compressed, and uncompressed parameters. The input bit stream 1406 is, in a preferred embodiment, the output of the SPE 103. The losslessly-compressed parameters are output by the DMUX 1402 to a lossless compression block 1408. The lossy-compressed parameters are output to a lossy-compression block 1410. The uncompressed parameters are output to the memory 116. The losslessly-compressed parameters are compressed by the block 1408 using a lossless method, such as, for example, the CTW algorithm, and the lossy-compressed parameters are compressed by the block 1410 using a lossy algorithm, such as, for example, lossy method 4. The LSF parameters and codebook gains are exemplary losslessly-compressed parameters. The innovation vector pulses are exemplary lossy-compressed parameters. The adaptive-codebook index is an exemplary uncompressed parameter. After compression, the losslessly and lossy-compressed parameters are input into the memory 116. Dashed-line 1412 illustrates those functions that, in a preferred embodiment, are performed y the FDEC 104.

When the compressed data is to be output by the memory 116, such as, for example, when a stored voice memo is played, the losslessly-compressed parameters are retrieved from the memory 116 and are decompressed by a lossless decompression block 1414. In a similar fashion, the lossy-compressed parameters are retrieved from the memory 116 and are decompressed by a lossy-decompression block 1416. The uncompressed parameters are also retrieved from the memory 116. After the compressed parameters have been decompressed, they are output to the MUX 1404 along with the uncompressed parameters. The MUX 1404 multiplexes the parameters into an output bit stream 1418. The output bit stream 1418 is, in a preferred embodiment, output by the FINT 109 to the SPD 110. Dashed line 1420 illustrates those functions that, in a preferred embodiment are performed by the FINT 109.

Tables 12 and 13 show resulting bit rates from the exemplary combined lossy and lossless compression for the EFR and the AMR 4.75 kbps mode codecs for 30, 60 and 90 seconds of speech.

TABLE 12
Average bit rate (in bits per second) for combined lossy and lossless
scheme in EFR

| Method | 30 s. | 60 s. | 90 s. |
|---|---|---|---|
| Context Tree Weighting | 5610 | 5555 | 5525 |
| Move-To-Front | 5895 | 5880 | 5870 |

TABLE 13
Average bit rate (in bits per second) for combined lossy and lossless
scheme in the AMR 4.75 kbps mode

| Method | 30 s. | 60 s. | 90 s. |
|---|---|---|---|
| Context Tree Weighting | 3030 | 2980 | 2950 |
| Move-To-Front | 3210 | 3205 | 3190 |

A compression percentage (R_{C}) is represented by:

$${R}_{C} = ( 1 - \frac{{R}_{A}}{{R}_{B}} ) \cdot 100 \% . \qquad ( 29 )$$

wherein R_{B} and R_{A} are the bit rates before and after compression, respectively. For 60 seconds of speech, the compression percentages for EFR are 54% (using CTW) and 52% (using MTF). For AMR 4.75 kbps, the corresponding results are 37% (using CTW) and 33% (using MTF).

It is desirable that the complete compression algorithm have a lower computational complexity than currently-used solutions, such as, for example, the HR codec. The lossy part of the algorithm is very simple. The complexity of the lossless part depends on which method is used. CTW has a high complexity; therefore, CTW would be difficult to implement in real-time if a greater depth than D=1 were used. Therefore, a relevant question is whether CTW with depth 1 is more complex than the HR codec.

If MTF is used, a number of Huffman codes must be stored in the encoder and in the decoder. In the case of AMR 4.75 kbps, five tables must be stored. Four of them have 256 entries and one has 128 entries, so some permanent memory is needed. This memory requirement can be reduced if Minimum Redundancy Prefix Codes are used instead of Huffman codes.

A compression method and apparatus based on frame redundancy in the bitstream produced by a speech encoder have been described. The compression method and apparatus reduce memory requirements and computational complexity for a voice memo functionality in mobile telephones. A thorough statistical study of the encoded bitstream was performed, and, based on this analysis, a combined lossy and lossless compression algorithm was developed. The HR codec is used for this function in today's mobile terminals. The present invention yields a lower bit rate than the HR codec. If the AMR 4.75 kbps mode is used, 37% more speech can be stored. The present invention has a lower complexity than the HR speech codec used in EFR and the suggested tandem connection for the voice memo function in AMR codecs.

A number of papers on inter-frame redundancy in the LSF parameters report that a high compression ratio can be achieved on the LSF parameters. This is the case when compressing actual parameters. In contrast, the present invention compresses codebook indices that denote residuals from predicted values of LSF parameters. These indices showed much lower redundancy than the actual LSF parameters as a result of multiple transformations.

When a lossy scheme is applied, speech quality is unavoidably degraded. Bearing in mind that an embodiment of the present invention reduces the bit rate for the AMR 4.75 kbps mode by 37%, it could be worthwhile to examine the possibility of designing an extra post-filter that enhances the speech quality. In addition, some other lossless methods could be examined, such as, for example, the Burrows-Wheeler method. This method is both faster and has a lower complexity than CTW. Considering the results from the entropy measurements and the number of lossless compression schemes tested, it appears that further compression beyond that described herein cannot be obtained without extra information from the speech encoder.

Other embodiments not shown are conceivable. For example, message data corresponding to a number of stored voice messages may be unalterably pre-stored in the memory. These messages may then be output by means of the loudspeaker or by means of the transmitter at the command of the user or as initiated by the controller.

For example, the controller may respond to a particular operational status of the communication apparatus by outputting a stored voice message to the user through the loudspeaker. In another example, the communication apparatus may operate in a manner similar to an automatic answering machine. Assuming that there is an incoming call to the communication apparatus and the user does not answer, a stored voice message may then be read out from the memory under the control of the controller and transmitted to the calling party by means of the transmitter. The calling party is informed by the output stored voice message that the user is unable to answer the call and that the user may leave a voice message. If the calling party chooses to leave a voice message, the voice message is received by the receiver, compressed by the frame decimation block, and stored in the memory by means of the controller. The user may later replay the stored message that was placed by the calling party by reading out the stored voice message from the memory and outputting it by means of the loudspeaker.

The communication devices 100, 200, 300, 400, and 500 discussed above may, for example, be a mobile telephone or a cellular telephone. A duplex filter may be introduced for connecting the antenna 107 with the output of the transmitter 106 and the input of the receiver 108. The present invention is not limited to radio communication devices, but may also be used for wired communication devices having a fixed-line connection. Moreover, the user may give commands to the communication devices 100, 200, 300, 400, and 500 by voice commands instead of, or in addition to, using the keyboard 117.

The frame decimation block 104 may more generally be labeled a code compression means and any algorithm performing compression may be used. Both algorithms introducing distortion (e.g., the methods described above) and algorithms being able to recreate the original signal completely, such as, for example, Ziv-Lempel or Huffman, can be used. The Ziv-Lempel algorithm and the Huffman algorithm are discussed in “Elements of Information Theory” by Thomas M. Cover, p. 319 and p. 92, respectively, which descriptions are hereby incorporated by reference. Likewise, the frame interpolation block 109 may more generally be labeled a code decompression means that employs an algorithm that substantially carries out the inverse operation of the algorithm used by the code compression means.

It should be noted that the term “communication device” of the present invention may refer to a hands-free equipment adapted to operate with another communication device, such as a mobile telephone or a cellular telephone. Furthermore, the elements of the present invention may be realized in different physical devices. For example, the frame interpolation block 109 and/or the frame decimation block 104 may equally well be implemented in an accessory to a cellular telephone as in the cellular telephone itself. Examples of such accessories are hands-free equipment and expansion units. An expansion unit may be connected to a system-bus connector of the cellular telephone and may thereby provide message-storing functions, such as dictating machine functions or answering machine functions.

The apparatus and method of operation of the present invention achieve the advantage that a voice message is stored in the memory in a more compressed format than the format provided by a speech encoder. Such a stored voice message is decompressed by the decompression means to recreate an encoded voice signal according to the speech encoding format (i.e., the format provided after a voice signal has passed a speech encoder).

Since a stored voice message is stored in the memory in a more compressed format than the format provided by a speech encoder, as is the case in the prior art, less memory is required to store a particular voice message. A smaller memory can therefore be used. Alternatively, a longer voice message can be stored in a particular memory. Consequently, the communication apparatus of the present invention requires less memory and is therefore cheaper to implement. For example, in small hand-held communication devices, in which memory is a scarce resource, the smaller amount of memory required provides obvious advantages. Furthermore, a small amount of computational power is required because simple decompression algorithms can be used by the decompression means.

Although several embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A communications apparatus comprising:
an encoder for encoding a signal;
a code compression unit, coupled to the encoder, for compressing the encoded signal using a lossless scheme and a lossy scheme; and
a memory, coupled to an output of the code compression unit, for storing the compressed encoded signal.

2. The apparatus of claim 1 further comprising:
a code decompression unit, coupled to the memory, for decompressing the stored signal using a lossless scheme and a lossy scheme; and
a decoder, coupled to the code decompression unit, for decoding the decompressed signal.

3. The apparatus of claim 2 wherein the quality of the signal decompressed using the lossy scheme is improved by changing weighting factors and a tilt factor in a post filter.

4. The apparatus of claim 1 wherein the lossless scheme is used to compress parameters of the encoded signal having high inter-frame redundancy.

5. The apparatus of claim 4 wherein the parameters of the encoded signal having high inter-frame redundancy includes coefficients of a long term filter and codebook gains.

6. The apparatus of claim 1 wherein the lossy scheme is used to compress some parameters of the encoded signal having low inter-frame redundancy.

7. The apparatus of claim 6 wherein the parameters of the encoded signal having low inter-frame redundancy that are compressed include fixed codebook indices.

8. The apparatus of claim 6 wherein the parameters of the encoded signal having low inter-frame redundancy that are not compressed include adaptive codebook indices.

9. The apparatus of claim 1 further comprising a switch that enables an encoded signal received by a receiver to be compressed by the code compression unit and stored in the memory.

10. The apparatus of claim 2 further comprising a switch that enables the stored signal to be decompressed by the decompression unit and output from a transceiver.

11. The apparatus of claim 1 further comprising an operator interface unit.

12. The apparatus of claim 1 wherein the apparatus is a mobile telephone or a communication device.

13. A method for compressing a signal comprising the steps of:
converting the signal to a digital signal;
encoding the digital signal;
compressing, within a compression unit, the encoded signal using a lossless scheme and a lossy scheme; and
storing the compressed encoded signal in a memory coupled to an output of the compression unit.

14. The method of claim 13 further comprising the steps of:
decompressing, within a decompressing unit, the stored signal using a lossless scheme and a lossy scheme;
decoding, within a decoder, the decompressed signal; and
outputting the decoded signal.

15. The method of claim 14 wherein the quality of the signal decompressed using the lossy scheme is improved by changing weighting factors and a tilt factor in a post filter of the decoder.

16. The method of claim 13 wherein the lossless scheme is used to compress parameters of the encoded signal having high inter-frame redundancy.

17. The method of claim 16 wherein the parameters of the encoded signal having high inter-frame redundancy include coefficients of a long term filter and codebook gains.

18. The method of claim 13 wherein the lossy scheme is used to compress some parameters of the encoded signal having low inter-frame redundancy.

19. The method of claim 18 wherein the parameters of the encoded signal having low inter-frame redundancy that are compressed include fixed codebook indices.

20. The method of claim 18 wherein the parameters of the encoded signal having low inter-frame redundancy that are not compressed include adaptive codebook indices.

21. A method of improving quality of a lossy-compressed signal comprising the steps of:
performing a lossy compression of an uncompressed signal to yield a lossy-compressed signal;
performing a transform of the uncompressed signal from time domain to frequency domain;
decompressing the lossy-compressed signal;
performing a transform of the decompressed lossy-compressed signal from time domain to frequency domain;
comparing an absolute value of the transformed uncompressed signal to the absolute value of the transformed decompressed lossy-compressed signal;
adjusting weighting factors and a tilt factor until a minimal difference between the absolute values of the transformed signals is reached; and
applying the adjusted weighting factors and the adjusted tilt factor to the decompressed lossy-compressed signal.

22. The method of claim 21 wherein the transforms are performed using short time Fourier transforms.

23. The method of claim 21 wherein the method is performed in an AMR codec.

24. The method of claim 21 wherein the method is performed in an EFR codec.

25. The method of claim 21 further comprising the step of performing a subjective listening test to confirm the adjusted factors.

26. An apparatus for improving quality of a lossy-compressed signal comprising:
a code compression unit adapted to lossy-compress an uncompressed signal;
a code decompression unit adapted to decompress the lossy-compressed signal; and
a processor adapted to:
perform a transform of the uncompressed signal and of the decompressed lossy-compressed signal from time domain to frequency domain;
compare an absolute value of the transformed uncompressed signal to an absolute value of the transformed decompressed lossy-compressed signal; and
adjust weighting factors and a tilt factor until a minimal difference between the absolute values of the transformed signals has been reached.

27. The apparatus of claim 26 further comprising a post filter adapted to apply the adjusted weighting factors and the adjusted tilt factor to the decompressed lossy-compressed signal.

28. The apparatus of claim 27 wherein the apparatus comprises part of an EFR codec.

29. The apparatus of claim 27 wherein the apparatus comprises part of an AMR codec.

30. A method of sorting parameters of an encoded speech signal for compression comprising the steps of:
determining a degree of inter-frame redundancy of each of the parameters;
lossy compressing a first portion of the parameters, the first portion having relatively low inter-frame redundancy; and
losslessly compressing a second portion of the parameters, the second portion having relatively high inter-frame redundancy.

31. The method of claim 30 further comprising the step of not compressing a third portion of the parameters, the third portion of the parameters being selected according to pre-determined criteria irrespective of inter-frame redundancy.

32. The method of claim 30 wherein the degree of inter-frame redundancy of each of the parameters is determined by statistical analysis.

33. The method of claim 30 the second portion includes coefficients of a long term filter and codebook gains.

34. The method of claim 30 wherein the first portion includes fixed codebook indices and adaptive codebook indices.

35. A method for decompressing a signal comprising the steps of:
decompressing, within a decompressing unit, a compressed encoded digital signal using a lossless scheme and a lossy scheme;
decoding, within a decoder, the decompressed signal; and
outputting the decoded signal.

36. The method of claim 35 wherein the quality of the decompressed signal is improved by changing weighting factors and a tilt factor in a post filter of the decoder.

37. The method of claim 35 further comprising the step of losslessly inter-frame redundancy.

38. The method of claim 37 wherein the parameters of the encoded digital signal having high inter-frame redundancy include coefficients of a long term filter and codebook gains.

39. The method of claim 35 further comprising the step of lossy compressing some parameters of an encoded digital signal, the parameters having low inter-frame redundancy.

40. The method of claim 39 wherein the parameters of the encoded signal having low inter-frame redundancy include fixed codebook indices.

41. The method of claim 39 wherein the parameters of the encoded signal having low inter-frame redundancy include adaptive codebook indices.
